(19) United States
(12) Patent Application Publication
(10) Pub. No.: US 2018/0244326 A1
(43) Pub. Date: Aug. 30, 2018

(54) TRACK SYSTEM FOR TRACTION OF A VEHICLE

(71) Applicant: CAMSO INC., MAGOG (CA)

(72) Inventor: JEREMIE ZUCHOSKI, SHERBROOKE (CA)

(21) Appl. No.: 15/755,377

(22) PCT Filed: Aug. 25, 2016
(86) PCT No.: PCT/CA2016/051004

§ 371 Date: Feb. 26, 2018

Related U.S. Application Data
(60) Provisional application No. 62/293,024, filed on Feb. 9, 2016.
(60) Provisional application No. 62/209,557, filed on Aug. 25, 2015.

(51) Int. Cl. B62D 55/10; B62D 55/24; B62M 27/02; B62D 55/125; B62D 55/084; B62D 55/07

(52) U.S. Cl. CPC B62D 55/10; B62D 55/244; B62M 27/02; B62D 55/065; B62D 55/084; B62D 55/07; B62D 55/125

(57) ABSTRACT

A track system for traction of a vehicle (e.g., a snowmobile, a snow bike, an all-terrain vehicle (ATV), an agricultural vehicle, etc.). The track system comprises a track and a track-engaging assembly for driving and guiding the track around the track-engaging assembly. The track system may be configured to enhance traction of the vehicle on the ground, such as by maintaining proper contact on the ground when the vehicle is leaned (e.g., for steering and/or over uneven terrain) and/or when the track system is subject to other loading that would otherwise tend to reduce tractive forces that it generates. For example, the track system may be configured such that, when the vehicle travels on the ground, a surface of the track-engaging assembly in contact with a bottom run of the track is movable relative to a frame of the vehicle to change an orientation of the surface of the track-engaging assembly in contact with the bottom run of the track relative to the frame of the vehicle.

### CROSS-REFERENCE TO RELATED APPLICATIONS

This application claims priority from U.S. Provisional Patent Applications 62/209,557 and 62/293,024 respectively filed on Aug. 25, 2015 and Feb. 9, 2016 and incorporated by reference herein.

### FIELD

The invention relates generally to off-road vehicles (e.g., snowmobiles, snow bikes, all-terrain vehicles (ATV), agricultural vehicles, etc.) and, more particularly, to track systems for traction of such vehicles.

### BACKGROUND

Certain off-road vehicles may be equipped with track systems which enhance their traction and floatation on soft, slippery and/or irregular grounds (e.g., snow, ice, soil, mud, sand, etc.) on which they operate.

For example, snowmobiles allow efficient travel on snowy and in some cases icy grounds. A snowmobile comprises a track system which engages the ground to provide traction. The track system comprises a track-engaging assembly and a track that moves around the track-engaging assembly and engages the ground to generate traction. The track typically comprises an elastomeric body in which are embedded certain reinforcements, such as transversal stiffening rods providing transversal rigidity to the track, longitudinal cables providing tensional strength, and/or fabric layers. The track-engaging assembly comprises wheels and in some cases slide rails around which the track is driven.

A snowmobile's user often leans on a side of the snowmobile in order to adjust the snowmobile's course and/or to stabilize the snowmobile over uneven terrain. In some cases, the user may even stand on the side of the snowmobile (generally known as “sidehilling”). Such practices subject the snowmobile to an off-centered loading (i.e., a loading offset from a center of the snowmobile along a widthwise direction of its track system) which can cause part of its track to apply less pressure onto the ground. The track may thus generate less traction on the ground in such instances.

A snow bike, which is a motorcycle equipped with a ski system and a track system respectively replacing its front and rear wheels, may similarly experience a decrease in traction when its rider leans towards a side of the snow bike.

Similar considerations may arise for track systems of other types of off-road vehicles (e.g., all-terrain vehicles (ATVs), agricultural vehicles, or other vehicles that travel on uneven grounds) in certain situations.

For these and other reasons, there is a need to improve track systems for off-road vehicles.

### SUMMARY

In accordance with various aspects of the invention, there is provided a track system for traction of a vehicle. The track system comprises a track and a track-engaging assembly for driving and guiding the track around the track-engaging assembly. The track system may be configured to enhance traction of the vehicle on the ground, such as by maintaining proper contact on the ground when the vehicle is leaned (e.g., for steering and/or over uneven terrain) and/or when the track system is subject to other loading that would otherwise tend to reduce tractive forces that it generates. For instance, the track system may be configured such that, when the vehicle travels on the ground, a surface of the track-engaging assembly in contact with a bottom run of the track is movable relative to a frame of the vehicle to change an orientation of the surface of the track-engaging assembly in contact with the bottom run of the track relative to the frame of the vehicle.

For example, in accordance with an aspect of the invention, there is provided a track system for traction of a vehicle. The track system comprises a track comprising a ground-engaging outer side for engaging the ground and an inner side opposite to the ground-engaging outer side. The track system further comprises a track-engaging assembly for driving and guiding the track around the track-engaging assembly. The track-engaging assembly comprises a drive wheel for driving the track and an elongate support comprising a rail extending in a longitudinal direction of the track system along a bottom run of the track. The elongate support comprises a sliding surface for sliding on the inner side of the track along the bottom run of the track. The rail comprises an upper portion and a lower portion between the upper portion and the sliding surface. When the vehicle travels on the ground, the upper portion of the rail is movable relative to the sliding surface to change an orientation of the upper portion of the rail relative to the sliding surface.

In accordance with another aspect of the invention, there is provided a track system for traction of a vehicle. The vehicle comprises a frame and a powertrain mounted to the frame. The track system comprises a track comprising a ground-engaging outer side for engaging the ground and an inner side opposite to the ground-engaging outer side. The track system further comprises a track-engaging assembly for driving and guiding the track around the track-engaging assembly. The track-engaging assembly comprises a drive wheel for driving the track and a rail extending in a longitudinal direction of the track system along a bottom run of the track. The rail overlaps a centerline of the track in a widthwise direction of the track system. When the vehicle travels on the ground, a surface of the track-engaging assembly in contact with the bottom run of the track is movable relative to the frame of the vehicle to change an orientation of the surface of the track-engaging assembly in contact with the bottom run of the track relative to the frame of the vehicle.

In accordance with another aspect of the invention, there is provided a track system for traction of a motorcycle. The track system is mountable in place of a rear wheel of the motorcycle. The track system comprises a track comprising a ground-engaging outer side for engaging the ground and an inner side opposite to the ground-engaging outer side. A ratio of a width of the track over a width of a tire of the rear wheel of the motorcycle is greater than two. The track system also comprises a track-engaging assembly for driving and guiding the track around the track-engaging assembly. The track-engaging assembly comprises a drive wheel for driving the track and a rail extending in a longitudinal direction of the track system along a bottom run of the track. The rail overlaps a centerline of the track in a widthwise direction of the track system.

In accordance with another aspect of the invention, there is provided a track system for traction of a motorcycle. The track system is mountable in place of a rear wheel of the motorcycle. The track system comprises a track comprising a ground-engaging outer side for engaging the ground and an inner side opposite to the ground-engaging outer side. The track system also comprises a track-engaging assembly for driving and guiding the track around the track-engaging assembly. The track-engaging assembly comprises a drive wheel for driving the track and an elongate support comprising a rail extending in a longitudinal direction of the track system along a bottom run of the track. The elongate support comprises a sliding surface for sliding on the inner side of the track along the bottom run of the track. The rail overlaps a centerline of the track in a widthwise direction of the track system. A ratio of a width of the track over a width of the sliding surface is at least 5.

In accordance with another aspect of the invention, there is provided a track system for traction of a motorcycle. The track system is mountable in place of a rear wheel of the motorcycle. The track system comprises a track comprising a ground-engaging outer side for engaging the ground and an inner side opposite to the ground-engaging outer side. A width of the track is greater than 10 inches. The track system also comprises a track-engaging assembly for driving and guiding the track around the track-engaging assembly. The track-engaging assembly comprises a drive wheel for driving the track and a rail extending in a longitudinal direction of the track system along a bottom run of the track. The rail overlaps a centerline of the track in a widthwise direction of the track system.

In accordance with another aspect of the invention, there is provided a track system for traction of a motorcycle. The track system is mountable in place of a rear wheel of the motorcycle. The track system comprises a track comprising a ground-engaging outer side for engaging the ground and an inner side opposite to the ground-engaging outer side. The track system also comprises a track-engaging assembly for driving and guiding the track around the track-engaging assembly. The track-engaging assembly comprises a drive wheel for driving the track and an elongate support comprising a rail extending in a longitudinal direction of the track system along a bottom run of the track. The elongate support comprises a sliding surface for sliding on the inner side of the track along the bottom run of the track. The rail comprises an upper portion and a lower portion between the upper portion and the sliding surface. When the motorcycle travels on the ground, the upper portion of the rail is movable relative to the sliding surface to change an orientation of the upper portion of the rail relative to the sliding surface.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 shows an example of a vehicle comprising a track system in accordance with an embodiment of the invention, in which the vehicle is a snowmobile;

FIGS. 2 and 3 respectively show a perspective and a side view of the track system;

FIGS. 4 and 5 respectively show a perspective and a side view of a track-engaging assembly of the track system;

FIG. 6 shows a cross-sectional perspective view of the track system as indicated in FIG. 3;

FIGS. 7 to 10 respectively show a perspective view, a plan view, an elevation view, and a longitudinal cross-sectional view of part of a track of the track system;

FIG. 11 shows a widthwise cross-sectional view of part of the track;

FIG. 12 shows a cross-sectional view of a rail of an elongate support of the track system as indicated in FIG. 5;

FIG. 13 shows a perspective view of a slider of the elongate support of the track system;

FIG. 14 shows a cross-sectional view of the slider as indicated in FIG. 13;

FIGS. 15 and 16 respectively show the rail in a neutral and a biased configuration;

FIG. 17 is a flowchart illustrating an example of a blow-molding process used to mold the frame;

FIG. 18 shows a cross-sectional view of a slider in accordance to another embodiment of the track system;

FIGS. 19 and 20 respectively show the slider of FIG. 18 in a neutral and a biased configuration;

FIGS. 21 and 22 respectively show a rail of a plurality of rails of the elongate support in a neutral and a biased configuration in accordance to a variant of the track system;

FIGS. 23 and 24 respectively show the rail and the slider in accordance to another variant of the track system in which the track-engaging assembly of the track comprises a movable mechanical joint between an upper part and a lower part of the track-engaging assembly;

FIGS. 25 and 26 respectively show an upper portion of the rail of the track system of FIGS. 23 and 24 in a neutral position and in an inclined position;

FIG. 27 shows an embodiment in which the movable mechanical joint comprises a resilient device;

FIGS. 28 to 31 are perspective, side, top and front views of the track-engaging assembly of the track system in accordance with another embodiment of the invention;

FIG. 32 is a partial cross-sectional view of the track-engaging assembly of FIG. 28 as it engages the track;

FIG. 33 is a side view of a roller wheel of the track-engaging assembly of FIG. 28 showing a vertical offset of a bottom of the roller wheel relative to a sliding surface of the elongate support;

FIG. 34 is an exploded view of part of the elongate support of the track-engaging assembly of FIG. 28;

FIGS. 35 and 36 are side and top views of part of the elongate support of the track-engaging assembly of FIG. 28;

FIGS. 37 and 38 show a ski system and a track system of a vehicle in accordance with another embodiment of the invention in which the vehicle is a snow bike, in this case where the ski system and the track system are respectively replacing a front wheel and a rear wheel of a motorcycle to convert the motorcycle into the snow bike;

FIG. 39 is a side view of the track system of FIGS. 37 and 38 showing a mounting arrangement of the track system;

FIG. 40 is a side view of the track system of FIGS. 37 and 38 showing a transmission of the mounting arrangement;

FIG. 41 is a perspective view of the transmission and a tensioner of the mounting arrangement;

FIG. 42 is an enlarged perspective view of part of the transmission and tensioner of the mounting arrangement;

FIG. 43 is a cross-sectional view of an elongated lateral member of a subframe of the mounting arrangement;

FIG. 44 is an enlarged perspective view of part of the mounting arrangement of the track system, showing a pivot of the subframe;

FIG. 45 is a side view of the snow vehicle showing a swing arm of the motorcycle when equipped with the front and rear wheels;

FIG. 46 shows a cross-sectional perspective view of the track system of FIGS. 37 and 38;

FIG. 47 shows the snow bike of FIGS. 37 and 38 as the motorcycle when it is equipped with its front and rear wheels instead of the ski system and the track system;

FIG. 48 shows a cross-section of the rear wheel of the motorcycle of FIG. 47;

FIGS. 49 and 50 respectively show side and top views of a vehicle, in this case an all-terrain vehicle (ATV), comprising track systems in accordance with another embodiment of the invention;

FIGS. 51 and 52 respectively show side and top views of the ATV of FIGS. 49 and 50 when the ATV is equipped with ground-engaging wheels;

FIGS. 53 and 54 respectively show a perspective and a side view of the track system of the ATV;

FIG. 55 shows a bottom view of the track system of the ATV;

FIGS. 56 and 57 respectively show a perspective and a side view of a track-engaging assembly of the track system of the ATV;

FIGS. 58 and 59 respectively show perspective views of a ground-engaging outer side and an inner side of the track of the track system of the ATV;

FIG. 60 shows a partial cross-sectional view of the track of the track system of the ATV, the track being free of stiffening rods; and

FIG. 61 shows a partial cross-sectional view of the track of the track system of the ATV in an embodiment in which the track comprises stiffening rods.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

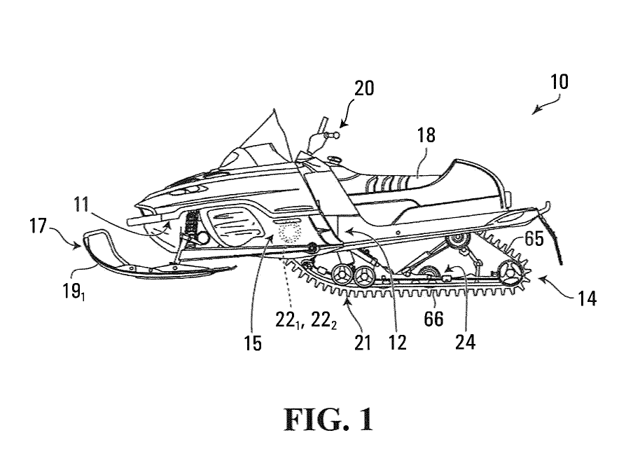

FIG. 1 shows an example of a tracked vehicle 10 in accordance with an embodiment of the invention. In this embodiment, the vehicle 10 is a snowmobile. The snowmobile 10 is designed for travelling on snow and in some cases ice.

The snowmobile 10 comprises a frame 11, a powertrain 12, a track system 14, a ski assembly 17, a seat 18, and a user interface 20, which enables a user to ride, steer and otherwise control the snowmobile 10.

As further discussed below, in this embodiment, the track system 14 is configured to enhance traction of the snowmobile 10 on the ground, including by maintaining proper contact on the ground when the user leans (and possibly even stands) on a lateral side of the snowmobile 10 to steer the snowmobile 10 and/or stabilize the snowmobile 10 over uneven terrain and/or when the track system 14 is subject to other loading that would otherwise tend to reduce tractive forces that it generates.

The powertrain 12 is configured for generating motive power and transmitting motive power to the track system 14 to propel the snowmobile 10 on the ground. To that end, the powertrain 12 comprises a prime mover 15, which is a source of motive power that comprises one or more motors (e.g., an internal combustion engine, an electric motor, etc.). For example, in this embodiment, the prime mover 15 comprises an internal combustion engine. In other embodiments, the prime mover 15 may comprise another type of motor (e.g., an electric motor) or a combination of different types of motor (e.g., an internal combustion engine and an electric motor). The prime mover 15 is in a driving relationship with the track system 14. That is, the powertrain 12 transmits motive power from the prime mover 15 to the track system 14 in order to drive (i.e., impart motion to) the track system 14.

The ski assembly 17 is turnable to allow steering of the snowmobile 10. In this embodiment, the ski assembly 17 comprises a pair of skis 19₁, 19₂ connected to the frame 11 via a front suspension unit.

The seat 18 accommodates the user of the snowmobile 10. In this case, the seat 18 is a straddle seat and the snowmobile 10 is usable by a single person such that the seat 18 accommodates only that person driving the snowmobile 10. In other cases, the seat 18 may be another type of seat, and/or the snowmobile 10 may be usable by two individuals, namely one person driving the snowmobile 10 and a passenger, such that the seat 18 may accommodate both of these individuals (e.g., behind one another) or the snowmobile 10 may comprise an additional seat for the passenger.

The user interface 20 allows the user to interact with the snowmobile 10 to control the snowmobile 10. More particularly, the user interface 20 comprises an accelerator, a brake control, and a steering device that are operated by the user to control motion of the snowmobile 10 on the ground. In this case, the steering device comprises handlebars, although it may comprise a steering wheel or other type of steering element in other cases. The user interface 20 also comprises an instrument panel (e.g., a dashboard) which provides indicators (e.g., a speedometer indicator, a tachometer indicator, etc.) to convey information to the user.

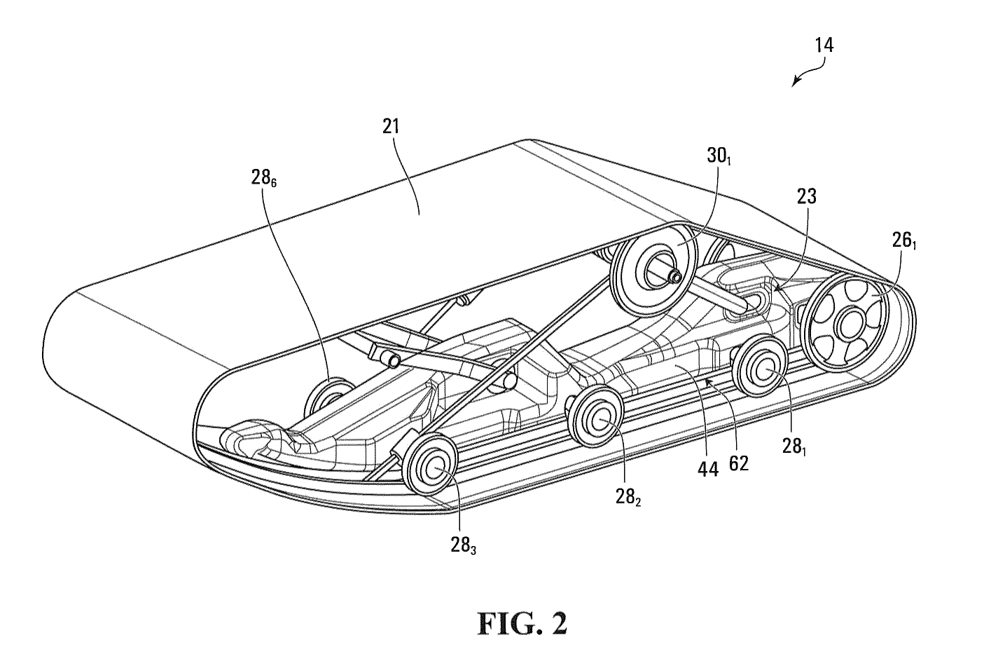

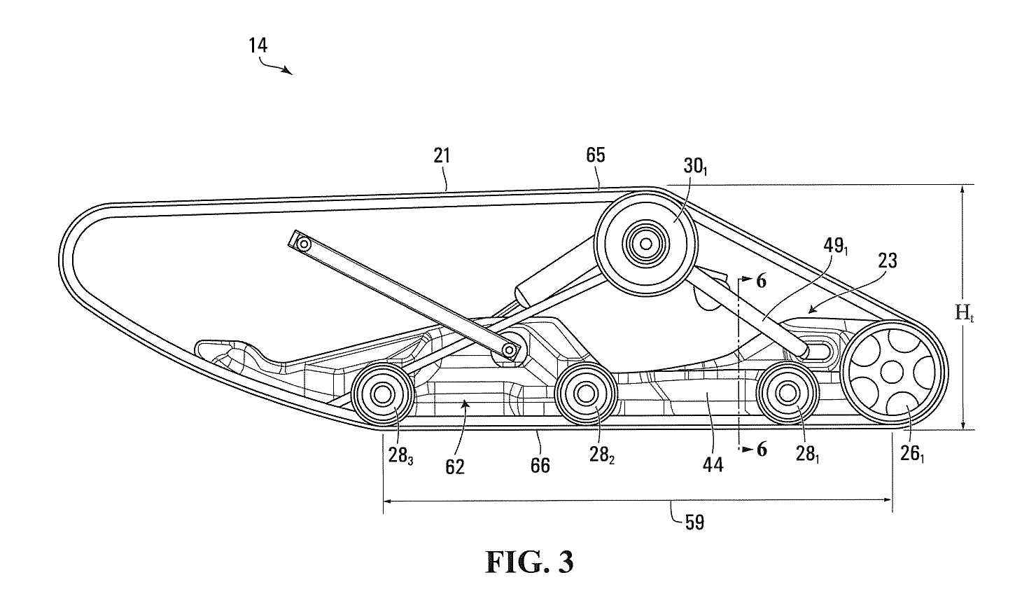

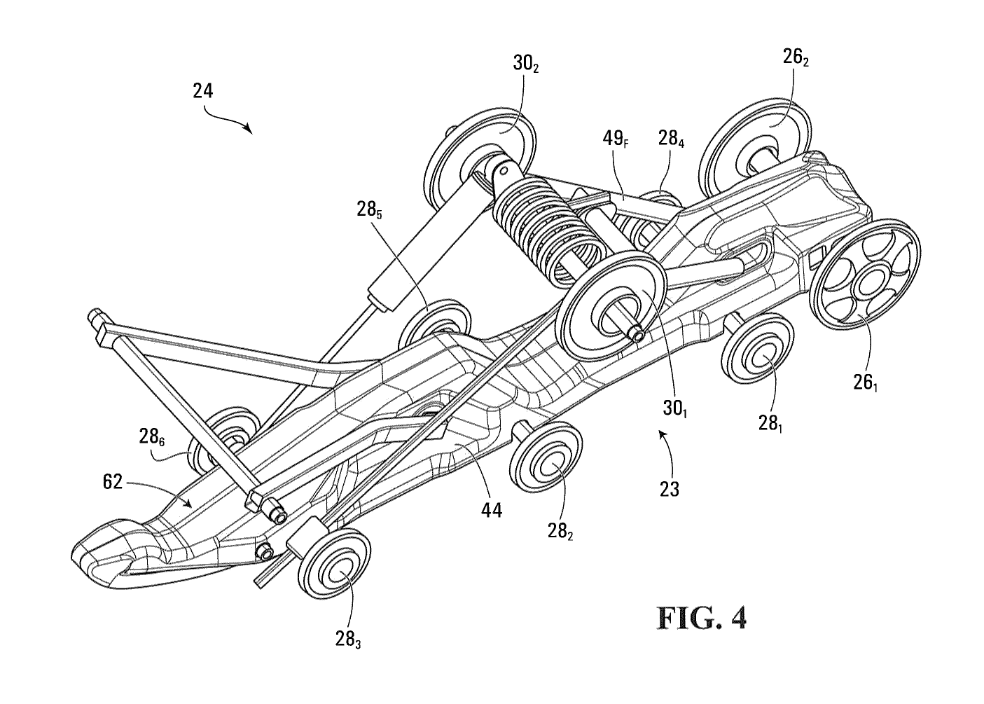

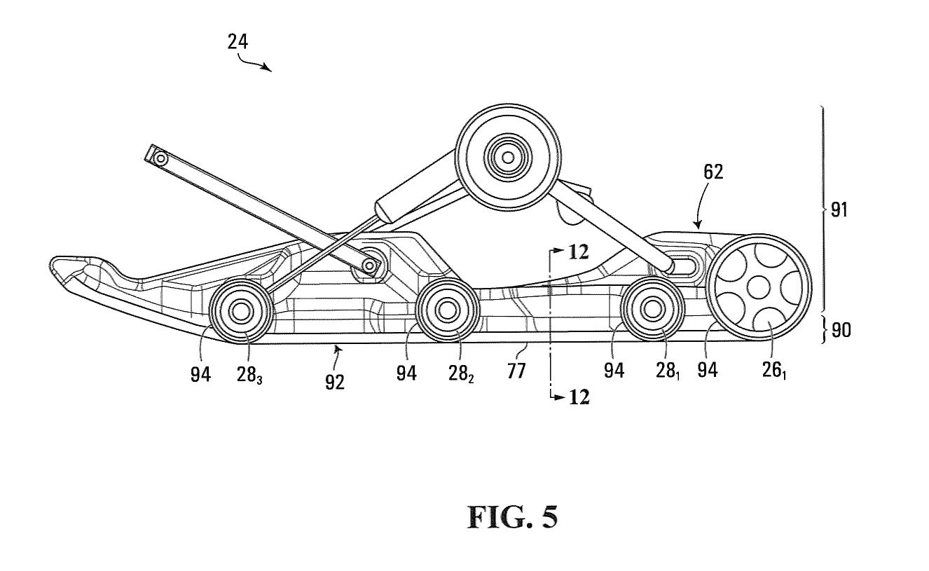

The track system 14 engages the ground to generate traction for the snowmobile 10. With additional reference to FIGS. 2 to 5, the track system 14 comprises a track-engaging assembly 24 and a track 21 disposed around the track-engaging assembly 24. More particularly, in this embodiment, the track-engaging assembly 24 comprises a frame 23 and a plurality of track-contacting wheels which includes a plurality of drive wheels 22₁, 22₂ and a plurality of idler wheels that includes rear idler wheels 26₁, 26₂, lower roller wheels 28₁-28₆, and upper roller wheels 30₁, 30₂. As it is disposed between the track 21 and the frame 11 of the snowmobile 10, the track-engaging assembly 24 can be viewed as implementing a suspension for the snowmobile 10. The track system 14 has a longitudinal direction and a first longitudinal end and a second longitudinal end that define a length of the track system 14, a widthwise direction and a width that is defined by a width of the track 21, and a height direction that is normal to its longitudinal direction and its widthwise direction.

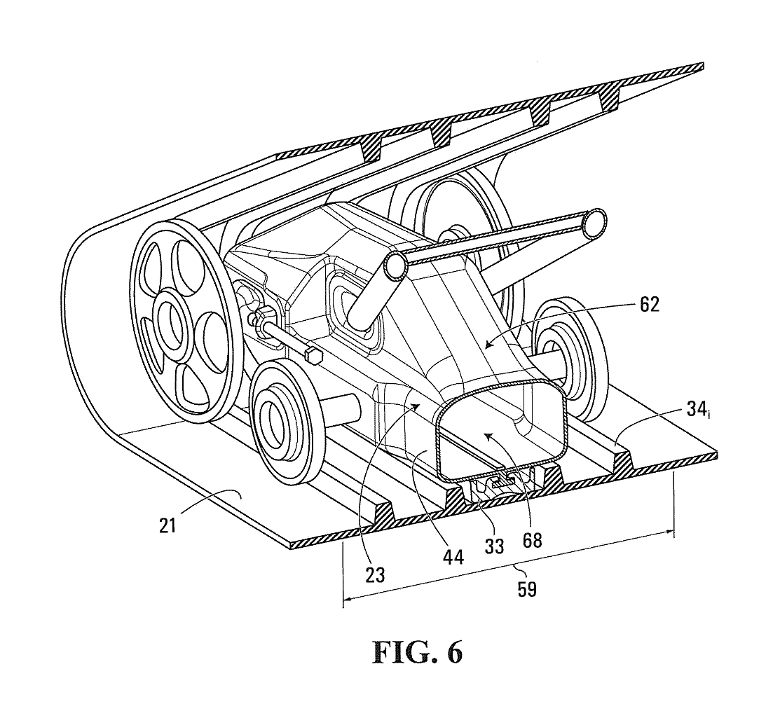

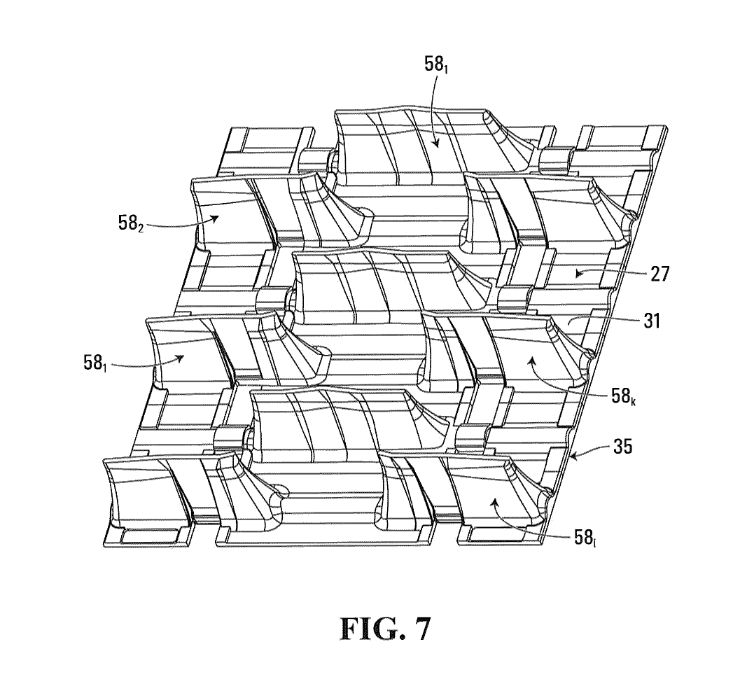

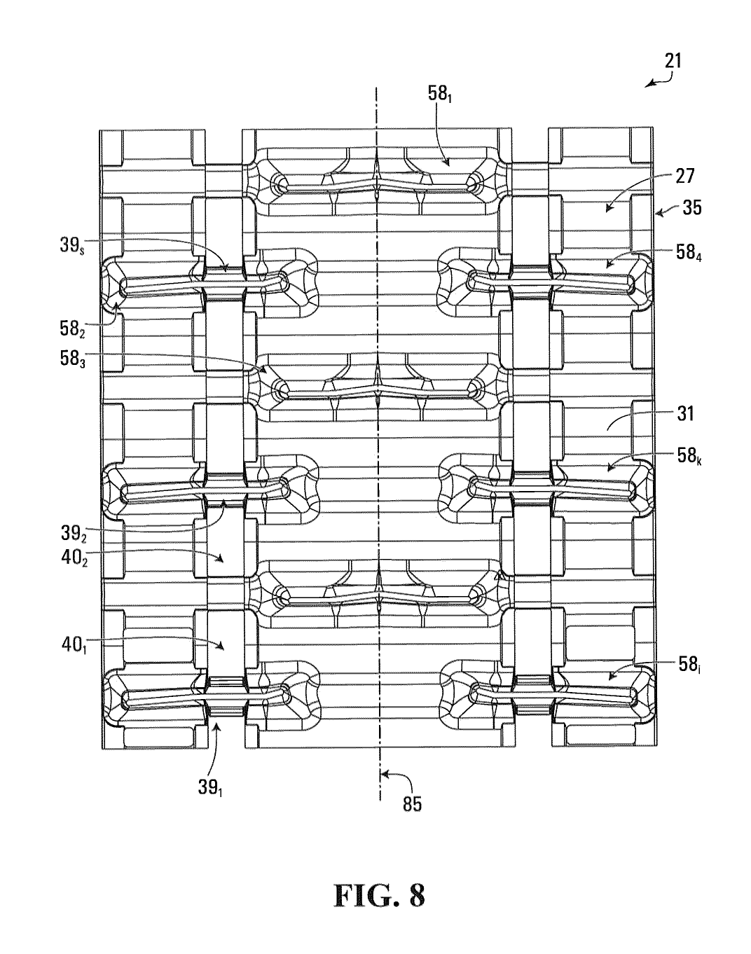

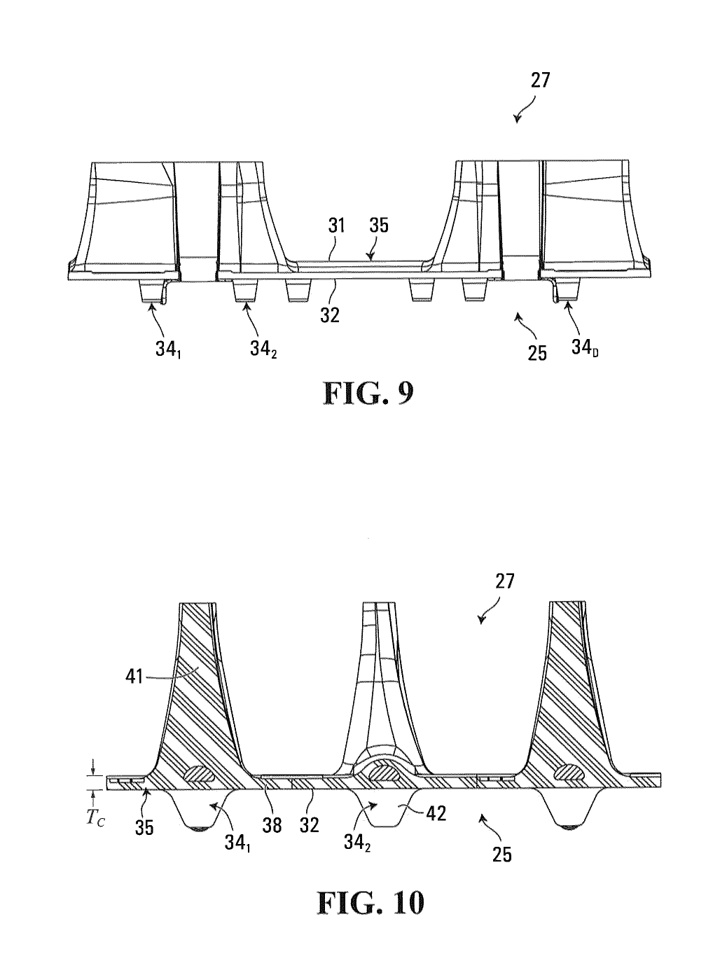

The track 21 engages the ground to provide traction to the snowmobile 10. A length of the track 21 allows the track 21 to be mounted around the track-engaging assembly 24. In view of its closed configuration without ends that allows it to be disposed and moved around the track-engaging assembly 24, the track 21 can be referred to as an “endless” track. With additional reference to FIGS. 6 to 9, the track 21 comprises an inner side 25 for facing the track-engaging assembly 24 and a ground-engaging outer side 27 for engaging the ground. A top run 65 of the track 21 extends between the longitudinal ends of the track system 14 and over the track-engaging assembly 24 (including over the wheels 22₁, 22₂, 26₁, 26₂, 28₁-28₆, 30₁, 30₂), and a bottom run 66 of the track 21 extends between the longitudinal ends of the track system 14 and under the track-engaging assembly 24 (including under the wheels 22₁, 22₂, 26₁, 26₂, 28₁-28₆, 30₁, 30₂). The bottom run 66 of the track 11 defines an area of contact 59 of the track 21 with the ground which generates traction and bears a majority of a load on the track system 14, and which will be referred to as a “contact patch” of the track 21 with the ground. The track 21 has a longitudinal axis which defines a longitudinal direction of the track 21 (i.e., a direction generally parallel to its longitudinal axis) and transversal directions of the track (i.e., directions transverse to its longitudinal axis), including a widthwise direction of the track (i.e., a lateral direction generally perpendicular to its longitudinal axis). The track 21 has a thickness direction normal to its longitudinal and widthwise directions.

The track 21 is elastomeric, i.e., comprises elastomeric material, to be flexible around the track-engaging assembly 24. The elastomeric material of the track 21 can include any polymeric material with suitable elasticity. In this embodiment, the elastomeric material of the track 21 includes rubber. Various rubber compounds may be used and, in some cases, different rubber compounds may be present in different areas of the track 21. In other embodiments, the elastomeric material of the track 21 may include another elastomer in addition to or instead of rubber (e.g., polyurethane elastomer).

More particularly, the track 21 comprises an endless body 35 underlying its inner side 25 and ground-engaging outer side 27. In view of its underlying nature, the body 35 will be referred to as a “carcass”. The carcass 35 is elastomeric in that it comprises elastomeric material 38 which allows the carcass 35 to elastically change in shape and thus the track 21 to flex as it is in motion around the track-engaging assembly 24. The elastomeric material 38 can be any polymeric material with suitable elasticity. In this embodiment, the elastomeric material 38 includes rubber. Various rubber compounds may be used and, in some cases, different rubber compounds may be present in different areas of the carcass 35. In other embodiments, the elastomeric material 38 may include another elastomer in addition to or instead of rubber (e.g., polyurethane elastomer).

In this embodiment, the carcass 35 comprises a plurality of reinforcements 45₁-45_{P} embedded in its rubber 38. These reinforcements 45₁-45_{P} can take on various forms.

For example, in this embodiment, a subset of the reinforcements 45₁-45_{P} is a plurality of transversal stiffening rods 36₁-36_{N} that extend transversally to the longitudinal direction of the track 21 to provide transversal rigidity to the track 21. More particularly, in this embodiment, the transversal stiffening rods 36₁-36_{N} extend in the widthwise direction of the track 21. Each of the transversal stiffening rods 36₁-36_{N} may have various shapes and be made of any suitably rigid material (e.g., metal, polymer or composite material).

As another example, in this embodiment, the reinforcement 45ᵢ is a layer of reinforcing cables 37₁-37_{M} that are adjacent to one another and extend generally in the longitudinal direction of the track 21 to enhance strength in tension of the track 21 along its longitudinal direction. In this case, each of the reinforcing cables 37₁-37_{M} is a cord including a plurality of strands (e.g., textile fibers or metallic wires). In other cases, each of the reinforcing cables 37₁-37_{M} may be another type of cable and may be made of any material suitably flexible longitudinally (e.g., fibers or wires of metal, plastic or composite material). In some examples of implementation, respective ones of the reinforcing cables 37₁-37_{M} may be constituted by a single continuous cable length wound helically around the track 21. In other examples of implementation, respective ones of the transversal cables 37₁-37_{M} may be separate and independent from one another (i.e., unconnected other than by rubber of the track 21).

As yet another example, in this embodiment, the reinforcement 45ⱼ is a layer of reinforcing fabric 43. The reinforcing fabric 43 comprises thin pliable material made usually by weaving, felting, knitting, interlacing, or otherwise crossing natural or synthetic elongated fabric elements, such as fibers, filaments, strands and/or others, such that some elongated fabric elements extend transversally to the longitudinal direction of the track 21 to have a reinforcing effect in a transversal direction of the track 21. For instance, the reinforcing fabric 43 may comprise a ply of reinforcing woven fibers (e.g., nylon fibers or other synthetic fibers). For example, the reinforcing fabric 43 may protect the transversal stiffening rods 36₁-36_{N}, improve cohesion of the track 21, and counter its elongation.

The carcass 35 may be molded into shape in a molding process during which the rubber 38 is cured. For example, in this embodiment, a mold may be used to consolidate layers of rubber providing the rubber 38 of the carcass 35, the reinforcing cables 37₁-37_{M} and the layer of reinforcing fabric 43.

In this embodiment, the track 21 is a one-piece “jointless” track such that the carcass 35 is a one-piece jointless carcass. In other embodiments, the track 21 may be a “jointed” track (i.e., having at least one joint connecting adjacent parts of the track 21) such that the carcass 35 is a jointed carcass (i.e., which has adjacent parts connected by the at least one joint). For example, in some embodiments, the track 21 may comprise a plurality of track sections interconnected to one another at a plurality of joints, in which case each of these track sections includes a respective part of the carcass 35. In other embodiments, the track 21 may be a one-piece track that can be closed like a belt with connectors at both of its longitudinal ends to form a joint.

The ground-engaging outer side 27 of the track 21 comprises a ground-engaging outer surface 31 of the carcass 35 and a plurality of traction projections 58₁-58_{T} that project from the ground-engaging outer surface 31 to enhance traction on the ground. The traction projections 58₁-58_{T}, which can be referred to as “traction lugs” or “traction profiles”, may have any suitable shape (e.g., straight shapes, curved shapes, shapes with straight parts and curved parts, etc.).

In this embodiment, each of the traction projection 58₁-58_{T} is an elastomeric traction projection in that it comprises elastomeric material 41. The elastomeric material 41 can be any polymeric material with suitable elasticity. More particularly, in this embodiment, the elastomeric material 41 includes rubber. Various rubber compounds may be used and, in some cases, different rubber compounds may be present in different areas of each of the traction projections 58₁-58_{T}. In other embodiments, the elastomeric material 41 may include another elastomer in addition to or instead of rubber (e.g., polyurethane elastomer).

The traction projections 58₁-58_{T} may be provided on the ground-engaging outer side 27 in various ways. For example, in this embodiment, the traction projections 58₁-58_{T} are provided on the ground-engaging outer side 27 by being molded with the carcass 35.

The inner side 25 of the track 21 comprises an inner surface 32 of the carcass 35 and a plurality of inner projections 34₁-34_{D} that project from the inner surface 32 and are positioned to contact the track-engaging assembly 24 (e.g., at least some of the wheels 22₁, 22₂, 26₁, 26₂, 28₁-28₆, 30₁, 30₂) to do at least one of driving (i.e., imparting motion to) the track 21 and guiding the track 21. Since each of them is used to do at least one of driving the track 21 and guiding the track 21, the inner projections 34₁-34_{D} can be referred to as “drive/guide projections” or “drive/guide lugs”. In some cases, a drive/guide lug 34ᵢ may interact with a given one of the drive wheels 22₁, 22₂ to drive the track 21, in which case the drive/guide lug 34ᵢ is a drive lug. In other cases, a drive/guide lug 34ᵢ may interact with a given one of the idler wheels 26₁, 26₂, 28₁-28₂, 30₁, 30₂ and/or another part of the track-engaging assembly 24 to guide the track 21 to maintain proper track alignment and prevent de-tracking without being used to drive the track 21, in which case the drive/guide lug 34ᵢ is a guide lug. In yet other cases, a drive/guide lug 34ᵢ may both (i) interact with a given one of the drive wheels 22₁, 22₃ to drive the track 21 and (ii) interact with a given one of the idler wheels 26₁, 26₂, 28₁-28₆, 30₁, 30₂ and/or another part of the track-engaging assembly 24 to guide the track 21, in which case the drive/guide lug 34ᵢ is both a drive lug and a guide lug.

In this embodiment, each of the drive/guide lugs 34₁-34_{D} is an elastomeric drive/guide lug in that it comprises elastomeric material 42. The elastomeric material 42 can be any polymeric material with suitable elasticity. More particularly, in this embodiment, the elastomeric material 42 includes rubber. Various rubber compounds may be used and, in some cases, different rubber compounds may be present in different areas of each of the drive/guide lugs 34₁-34_{D}. In other embodiments, the elastomeric material 42 may include another elastomer in addition to or instead of rubber (e.g., polyurethane elastomer).

The drive/guide lugs 34₁-34_{D} may be provided on the inner side 25 in various ways. For example, in this embodiment, the drive/guide lugs 34₁-34_{D} are provided on the inner side 25 by being molded with the carcass 35.

In this embodiment, the carcass 35 has a thickness T_{c} which is relatively small. The thickness T_{c} of the carcass 35 is measured from the inner surface 32 to the ground-engaging outer surface 31 of the carcass 35 between longitudinally-adjacent ones of the traction projections 58₁-58_{T}. For example, in some embodiments, the thickness T_{c} of the carcass 35 may be no more than 0.25 inches, in some cases no more than 0.22 inches, in some cases no more than 0.20 inches, and in some cases even less (e.g., no more than 0.18 or 0.16 inches). The thickness T_{c} of the carcass 35 may have any other suitable value in other embodiments.

The track-engaging assembly 24 is configured to drive and guide the track 21 around the track-engaging assembly 24.

Each of the drive wheels 22₁, 22₂ is rotatable by an axle for driving the track 21. That is, power generated by the prime mover 15 and delivered over the powertrain 12 of the snowmobile 10 rotates the axle, which rotates the drive wheels 22₁, 22₂, which impart motion of the track 21. In this embodiment, each drive wheel 22ᵢ comprises a drive sprocket engaging some of the drive/guide lugs 34₁-34_{D} of the inner side 25 of the track 21 in order to drive the track 21. In other embodiments, the drive wheel 22ᵢ may be configured in various other ways. For example, in embodiments where the track 21 comprises drive holes, the drive wheel 22ᵢ may have teeth that enter these holes in order to drive the track 21. As yet another example, in some embodiments, the drive wheel 22ᵢ may frictionally engage the inner side 25 of the track 21 in order to frictionally drive the track 21. The drive wheels 22₁, 22₂ may be arranged in other configurations and/or the track system 14 may comprise more or less drive wheels (e.g., a single drive wheel, more than two drive wheels, etc.) in other embodiments.

The idler wheels 26₁, 26₂, 28₁-28₆, 30₁, 30₂ are not driven by power supplied by the prime mover 15, but are rather used to do at least one of guiding the track 21 as it is driven by the drive wheels 22₁, 22₂, tensioning the track 21, and supporting part of the weight of the snowmobile 10 on the ground via the track 21. More particularly, in this embodiment, the rear idler wheels 26₁, 26₂ are trailing idler wheels that maintain the track 21 in tension, guide the track 21 as it wraps around them, and can help to support part of the weight of the snowmobile 10 on the ground via the track 21. The lower roller wheels 28₁-28₆ roll on the inner side 25 of the track 21 along the bottom run 66 of the track 21 to apply the bottom run 66 on the ground. The upper roller wheels 30₁, 30₂ roll on the inner side 25 of the track 21 along the top run 65 of the track 21 to support and guide the top run 65 as the track 21 moves. The idler wheels 26₁, 26₂, 28₁-28₆, 30₁, 30₂ may be arranged in other configurations and/or the track assembly 14 may comprise more or less idler wheels in other embodiments.

The frame 23 of the track system 14 supports various components of the track-engaging assembly 24, including, in this embodiment, the idler wheels 26₁, 26₂, 28₁-28₆, 30₁, 30₂. More particularly, in this embodiment, the frame 23 comprises an elongate support 62 extending in the longitudinal direction of the track system 14 along the bottom run 66 of the track 21 and frame members 49₁-49_{F} extending upwardly from the elongate support 62.

The elongate support 62 comprises a rail 44 extending in the longitudinal direction of the track system 14 along the bottom run 66 of the track 21. In this example, the idler wheels 26₁, 26₂, 28₁-28₆ are mounted to the rail 44. In this embodiment, the elongate support 62 comprises a sliding surface 77 for sliding on the inner side 25 of the track 21 along the bottom run 66 of the track 21. Thus, in this embodiment, the idler wheels 26₁, 26₂, 28₁-28₆ and the sliding surface 77 of the elongate support 62 can contact the bottom run 66 of the track 21 to guide the track 21 and apply it onto the ground for traction.

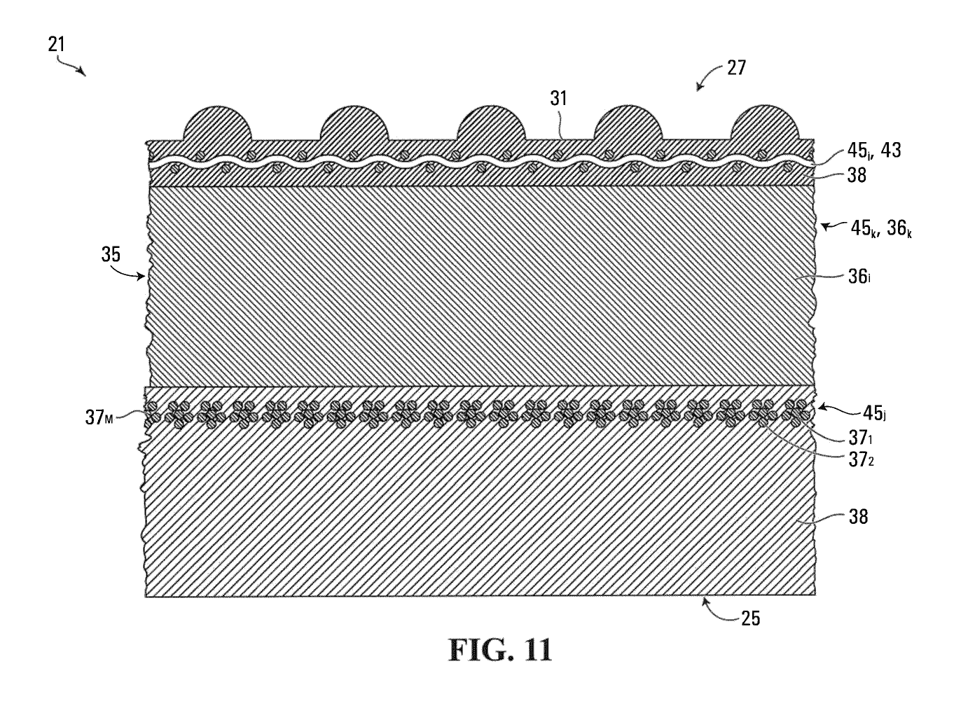

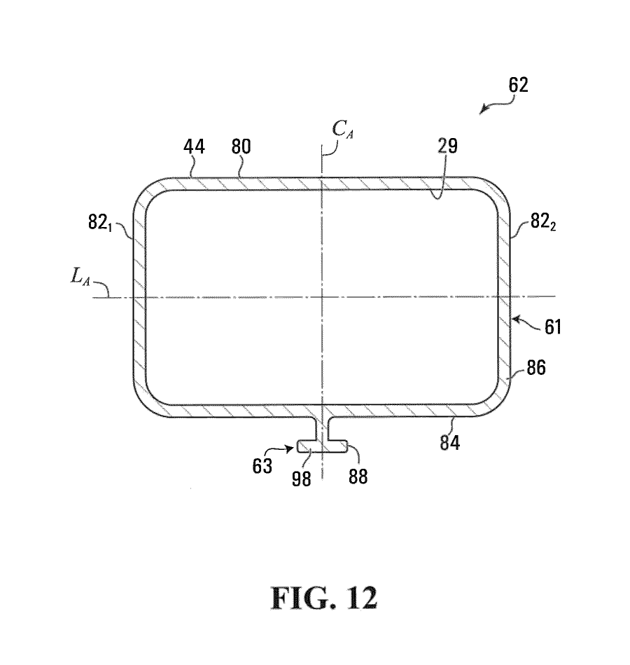

The rail 44 is an elongate structure that is elongated in the longitudinal direction of the track system 14 and comprises an upper portion 61 and a lower portion 63 between the upper portion 61 and the sliding surface 77, as shown in FIG. 12. More particularly, the rail 44 comprises a top 80, lateral surfaces 82₁, 82₂ opposite one another, and a bottom 84. Axles of the idler wheels 26₁, 26₂, 28₁-28₆ are carried by the rail 44 such that the idler wheels 26₁, 26₂, 28₁-28₆ are adjacent to respective ones of the lateral surfaces 82₁, 82₂ of the rail 44.

In this example, the rail 44 is a sole rail of the track-engaging assembly 24, which may thus be viewed as implementing a “single-rail suspension”. In other words, the track-engaging assembly 24 has a single rail (i.e., it is free of any other rail). The rail 44 is disposed in a central region of the track-engaging assembly 24. More particularly, in this embodiment, the rail 44 overlaps a centerline 85 of the track 21 (i.e., a line that bisects the width of the track 21) in the widthwise direction of the track system 14. In this example, the sliding surface 77 overlaps the centerline 85 of the track 21. This is in contrast to a snowmobile's conventional track system which comprises a plurality of rails that are spaced apart from one another in the track system's widthwise direction such that they do not overlap a centerline of a track of the track system.

In some embodiments, as shown in FIGS. 2 to 6, in a cross-section of the track system 14 in the widthwise direction of the track system 14, the sliding surface 77 of the rail 44 and a bottom 55 of each of the roller wheels 28₁-28₆ between which the rail 44 is disposed may be aligned in the heightwise direction of the track system 14. The inner surface 32 of the track 21 in contact with the sliding surface 77 of the rail 44 and the bottom 55 of each of the roller wheels 28₁-28₆ is thus substantially even (i.e., flat) in the widthwise direction of the track 21.

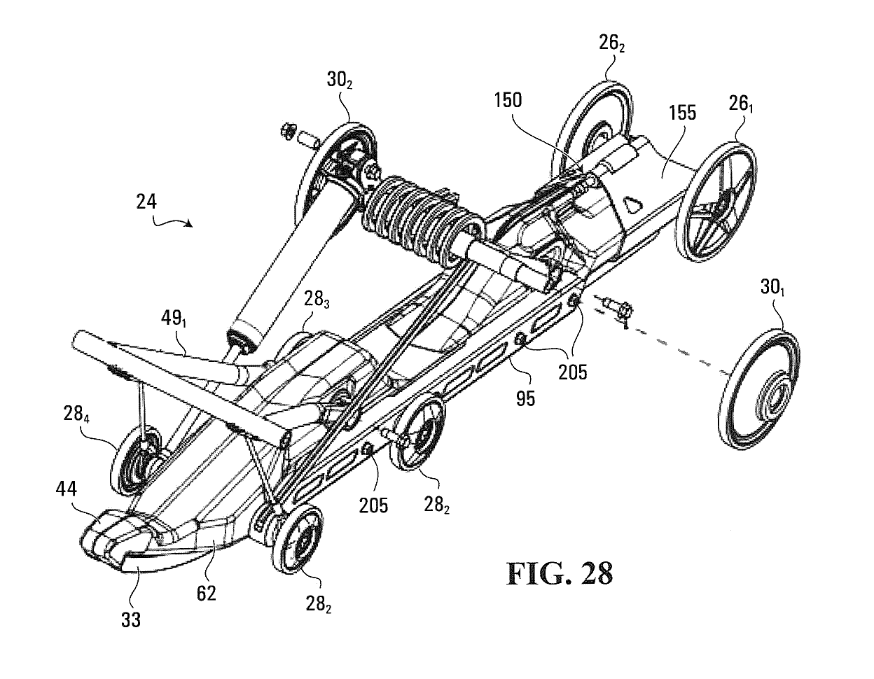

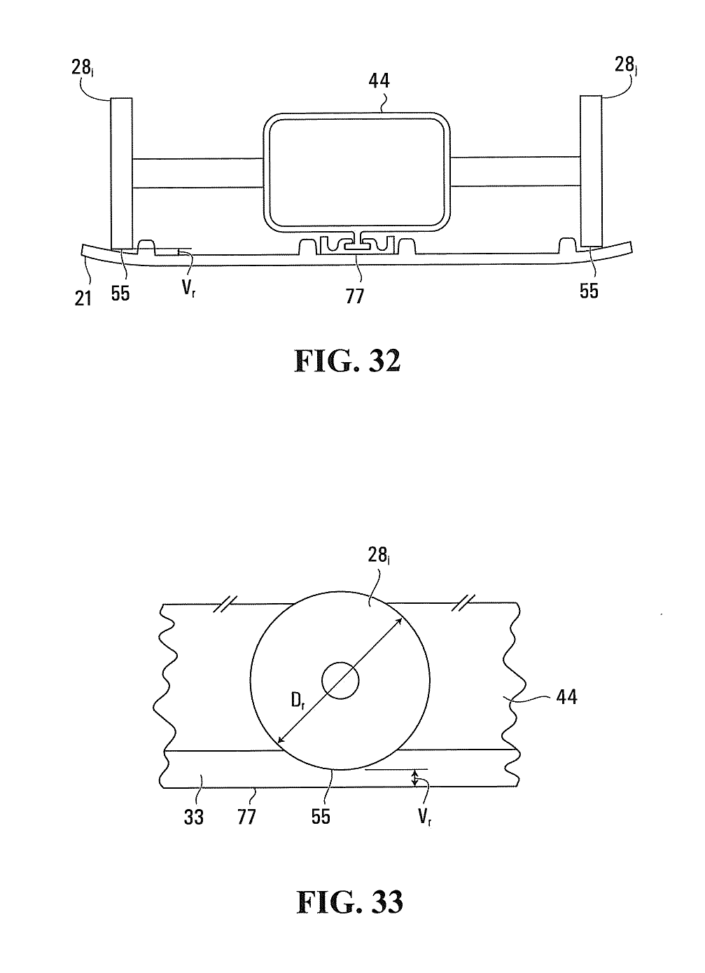

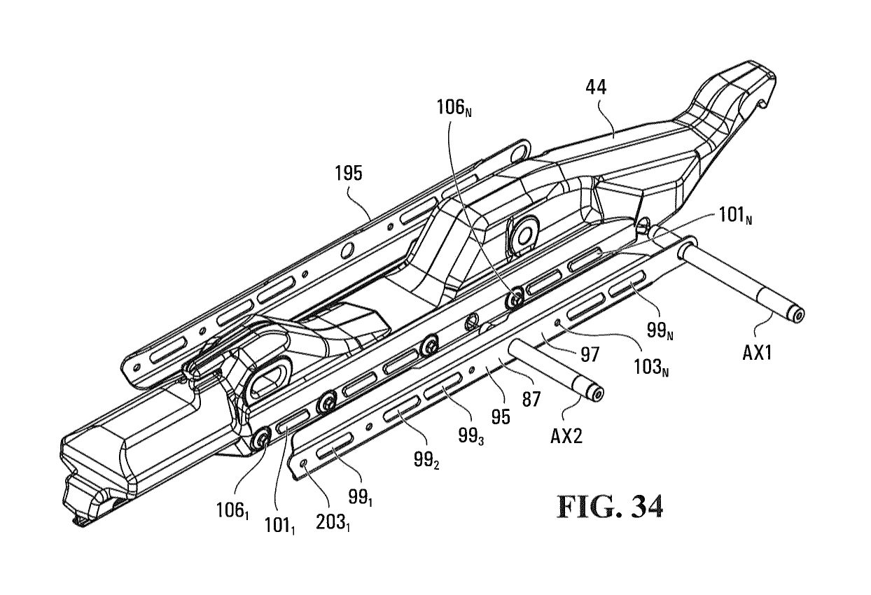

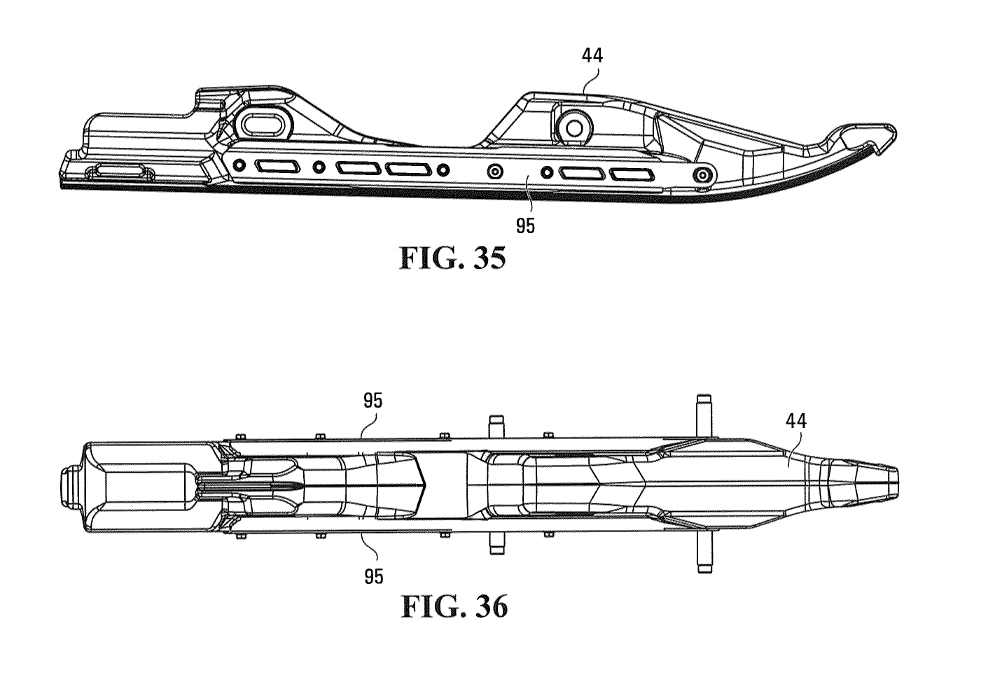

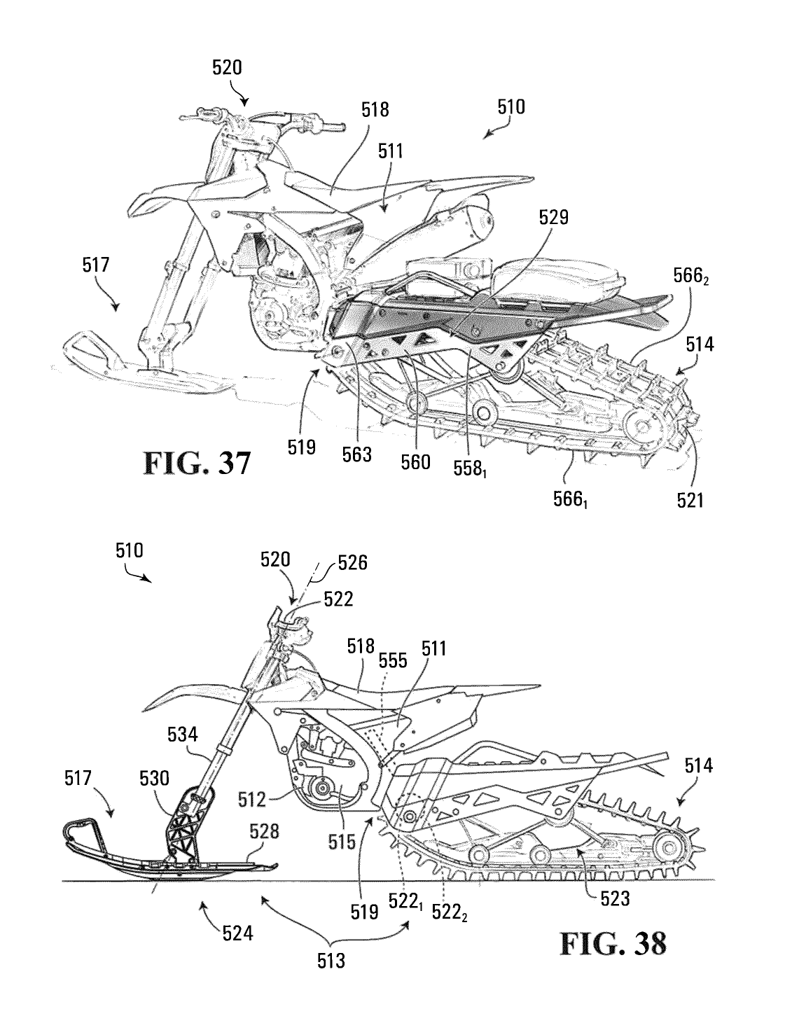

In other embodiments, as shown in FIGS. 28 to 36, in a cross-section of the track system 14 in the widthwise direction of the track system 14, the sliding surface 77 of the rail 44 and the bottom 55 of at least some of the roller wheels 28₁-28₄ between which the rail 44 is disposed may be offset in the heightwise direction of the track system 14 (in this example, the track-engaging assembly 24 comprises four roller wheels 28₁-28₄, but could comprise more or less such roller wheels in other examples). There is thus an offset Vᵣ between the sliding surface 77 of the rail 44 and the bottom 55 of some of the roller wheels 28₁-28₄ in the heightwise direction of the track system 14. The inner surface 32 of the track 21 in contact with the sliding surface 77 of the rail 44 and the bottom 55 of each of the roller wheels 28₁-28₄ is therefore uneven (i.e., not flat) in the widthwise direction of the track 21. This may help to facilitate transitioning of the snowmobile from its upright position towards its leaning position.

More particularly, in this embodiment, the bottom 55 of at least some of the roller wheels 28₁-28₄ is located higher than the sliding surface 77 of the rail 44 in the heightwise direction of the track system 14. The inner surface 32 of the track 21 in contact with the sliding surface 77 of the rail 44 and the bottom 55 of each of the roller wheels 28₁-28₄ is thus generally concave, curving or otherwise extending upwardly from the sliding surface 77 of the rail 44 towards the bottom 55 of each of the roller wheels 28₁-28₄.

The offset Vᵣ between the sliding surface 77 of the rail 44 and the bottom 55 of at least some of the roller wheels 28₁-28₄ may have any suitable value. For example, in some embodiments, a ratio Vᵣ/Hₜ of the offset Vᵣ between the sliding surface 77 of the rail 44 and the bottom 55 of at least some of the roller wheels 28₁-28₄ over a height Hₜ of the track system 14 may be at least 0.01, in some cases at least 0.02, in some cases at least 0.03, and in some cases even more. As another example, in some embodiments, a ratio Vᵣ/Dᵣ of the offset Vᵣ between the sliding surface 77 of the rail 44 and the bottom 55 of at least some of the roller wheels 28₁-28₄ over a diameter Dᵣ of a roller wheel 28ᵢ may be at least 0.05, in some cases at least 0.07, in some cases at least 0.1, and in some cases even more.

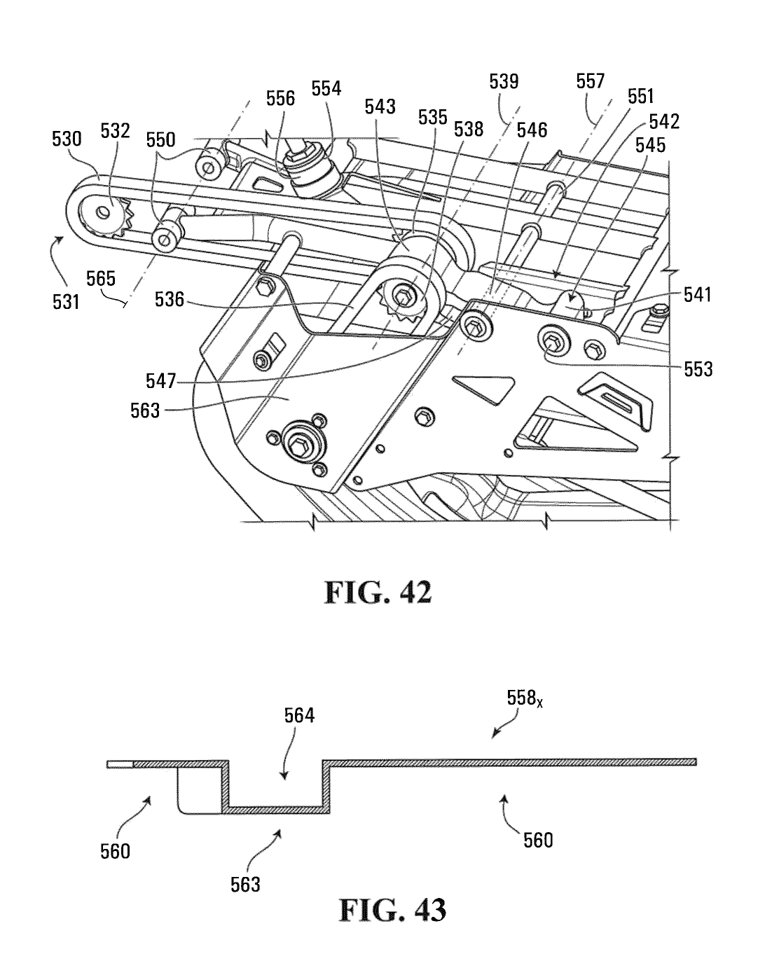

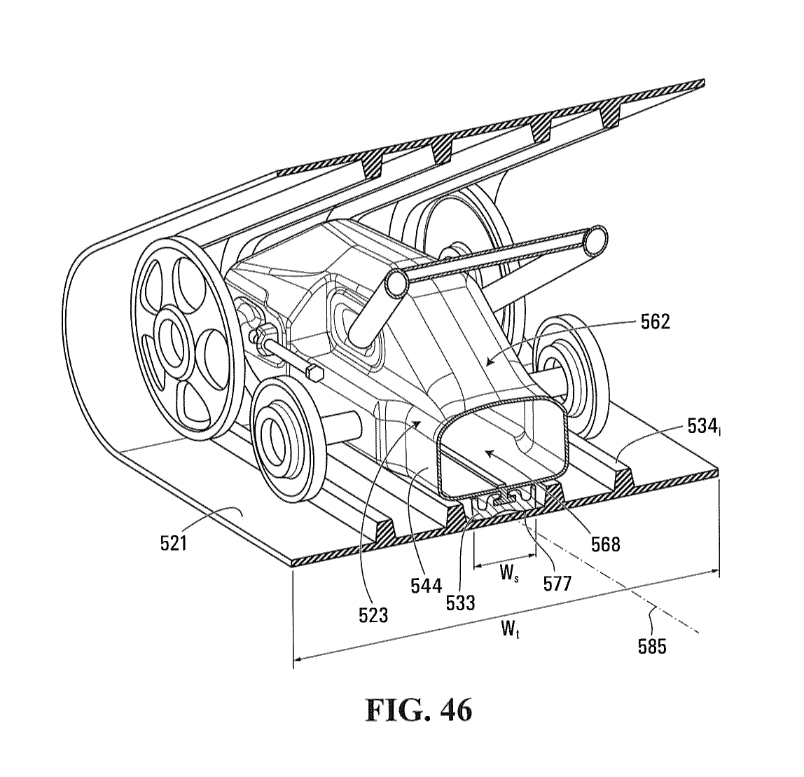

Furthermore, in the embodiment of FIGS. 42 to 50, the offset Vᵣ between the sliding surface 77 of the rail 44 and the bottom 55 of at least some of the roller wheels 28₁-28₄ is implemented by a selected pair of laterally-adjacent ones of the roller wheels roller wheels 28₁-28₄ (roller wheels which are adjacent to one another in the widthwise direction of the track system 14). This selected pair of laterally-adjacent ones of the roller wheels roller wheels 28₁-28₄ are therefore not used for relieving pressure on the sliding surface 77 of the rail 44, but rather to provide a limit to the leaning position of the snowmobile 10 (e.g., when the snowmobile 10 is turning). In this example, the selected pair of laterally-adjacent ones of the roller wheels 28₁-28₄ which implements the offset Vᵣ is the roller wheels 28₂, 28₄ which constitute a frontmost pair of the roller wheels 28ᵢ-28₄ (i.e., a pair of the roller wheels which is closest to a frontmost point of the track system 14 in its longitudinal direction). The other roller wheels 28₁, 28₃ do no implement the offset Vᵣ such that the sliding surface 77 of the rail 44 and the bottom 55 of each of the roller wheels 28₁, 28₃ is generally aligned in the heightwise direction of the track system 14. Moreover, as shown in FIGS. 42, 44 and 45, in this embodiment, the roller wheels 28₂, 28₄ which implement the offset Vᵣ are spaced laterally from the rail 44 more than the remainder of the roller wheels 28₁-28₄ (i.e., more than the roller wheels 28₁, 28₃).

In other examples, more than a single pair of the roller wheels 28₁-28₄ may implement the offset Vᵣ. For instance, in cases where the track system 14 comprises more than four roller wheels (such as in the embodiment of FIGS. 2 to 6), two pairs of the roller wheels 28₁-28₆ may implement the offset Vᵣ.

Furthermore, in this embodiment, the offset Vᵣ between the sliding surface 77 of the rail 44 and the bottom 55 of at least some of the roller wheels 28₁-28₄ (i.e., the roller wheels 28₂, 28₄) is implemented by making the diameter Dᵣ of the at least some of the roller wheels 28₁-28₄ smaller than the diameter of the other roller wheels 28₁-28₄. More particularly, since an axle AX1 of the roller wheels 28₂, 28₄ is aligned with an axle AX2 of the roller wheels 28₁, 28₃ in the heightwise direction of the track system 14, making the diameter Dᵣ of the roller wheels 28₂, 28₄ smaller than the diameter of the roller wheels 28₁, 28₃, implements the offset Vᵣ between the sliding surface 77 of the rail 44 and the bottom 55 of the roller wheels 28₂, 28₄.

The offset Vᵣ between the sliding surface 77 of the rail 44 and the bottom 55 of the roller wheels 28₂, 28₄ may be implemented differently in other embodiments. For instance, in some embodiments, rather than making the diameter Dᵣ of the roller wheels 28₂, 28₄ smaller, the axle AX1 of the roller wheels 28₂, 28₄ may be supported at a point higher in the heightwise direction of the track system 14 than the axle AX2 of the roller wheels 28₁, 28₃, such that the axle AX1 of the roller wheels 28₂, 28₄ is not aligned with the axle AX2 of the roller wheels 28₁, 28₃ in the heightwise direction of the track system 14.

The frame members 49₁-49_{F} extend upwardly from the elongate support 62 to hold the upper roller wheels 30₁, 30₂ such that the upper roller wheels 30₁, 30₂ roll on the inner side 25 of the track 21 along the top run 65 of the track 21.

The frame 23 of the track system 14, including the rail 44, may comprise any suitable material imparting strength to the frame 23. In some cases, a single material may make up an entirety of the frame 23. In other cases, different materials may make up different portions of the frame 23 (e.g., one material making up the rail 44, another material making up another part of the frame 23 above the rail 44).

In this embodiment, the frame 23 comprises a nonmetallic material 86 making up at least a significant part (e.g., at least a majority) of the frame 23, including the rail 44. More particularly, in this embodiment, the nonmetallic material 86 is a polymeric material. In some cases, the polymeric material 86 may include a single polymer. In other cases, the polymeric material 86 may include a combination of polymers. In yet other cases, the polymeric material 86 may include a polymer-matrix composite comprising a polymer matrix in which reinforcements are embedded (e.g., a fiber-reinforced polymer such as a carbon-fiber-reinforced polymer or glass-fiber-reinforced polymer). In this example of implementation, the polymeric material 86 includes high-density polyethylene (e.g., high molecular weight high-density polyethylene). Any other suitable polymer may be used in other examples of implementation (e.g., polypropylene, polyurethane, polycarbonate, low-density polyethylene, nylon, etc.).

In other embodiments, the frame 23 may comprise a metallic material (e.g., aluminum, steel, etc.) or any other suitable material making up at least a significant part (e.g., at least a majority) of the frame 23, including the rail 44.

The sliding surface 77 of the elongate support 62 is configured to slide on the inner side 25 of the track 21 along the bottom run 66 of the track 21 to guide the track 21 and apply it onto the ground. In this embodiment, the sliding surface 77 can slide against the inner surface 32 of the carcass 35 and can contact respective ones of the drive/guide lugs 34₁-34_{D} to guide the track 21 in motion. Also, in this embodiment, the sliding surface 77 is curved upwardly in a front region of the track system 14 to guide the track 21 towards the drive wheels 22₁, 22₂. In some cases, the track 21 may comprise slide members 39₁-39_{S} that slide against the sliding surface 77 to reduce friction. The slide members 39₁-39_{S}, which can sometimes be referred to as “clips”, may be mounted via holes 40₁-40_{H} of the track 21. In other cases, the track 21 may be free of such slide members. The sliding surface 77 may be arranged in other configurations in other embodiments.

In this embodiment, the elongate support 62 comprises a slider 33 mounted to the rail 44 and comprising the sliding surface 77. More particularly, in this embodiment, the slider 33 is mechanically interlocked with the rail 44. The slider 33 comprises an interlocking portion 78 that is interlockable with an interlocking portion 88 of the rail 44 in order to mechanically interlock the slider 33 and the rail 44. The interlocking portion 88 of the rail 44 and the interlocking portion 78 of the slider 33 are mechanically interlocked by a given one of the interlocking portion 88 of the rail 44 and the interlocking portion 78 of the slider 33 comprising an interlocking space (e.g., one or more holes, one or more recesses, and/or one or more other hollow areas) into which extends an interlocking part of the other one of the interlocking portion 88 of the rail 44 and the interlocking portion 78 of the slider 33.

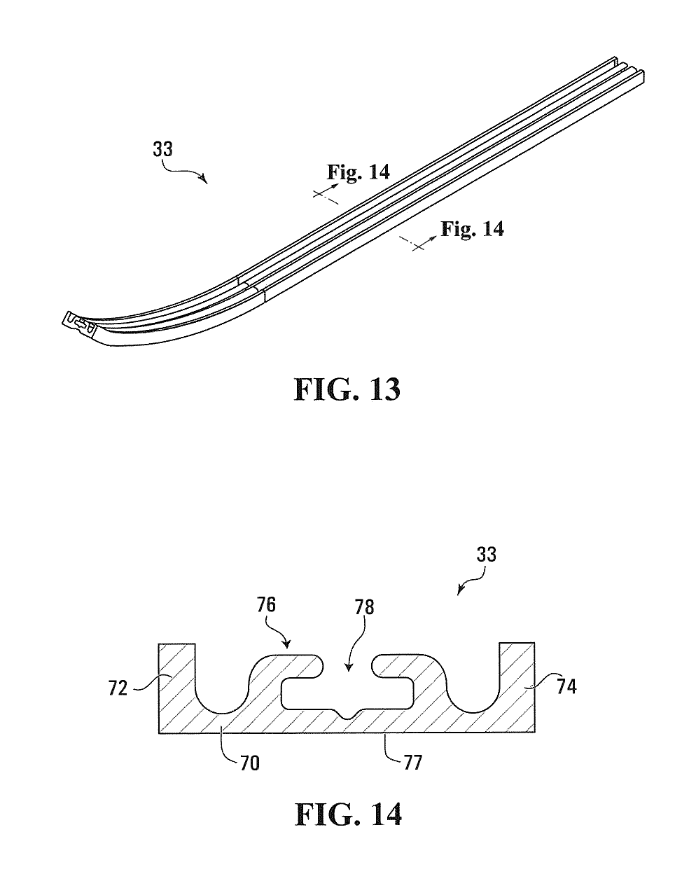

More particularly, with additional reference to FIGS. 13 and 14, in this embodiment, the slider 33 comprises a base 70 extending in the widthwise direction of the track system 14, a pair of projections 72, 74 that project upwardly from the base 70, and a mating portion 76 that is configured to mate with the rail 44 and defines the interlocking portion 78 of the slider 33. In this example, the interlocking portion 78 of the slider 33 comprises an aperture for receiving the interlocking portion 88 of the rail 44.

In other embodiments, instead of or in addition to being mechanically interlocked with the rail 44, the slider 33 may be fastened to the rail 44. For example, in some embodiments, the slider 33 may be fastened to the rail 44 by one or more mechanical fasteners (e.g., bolts, screws, etc.), by an adhesive, and/or by any other suitable fastener.

In some examples, the slider 33 may comprise a low-friction material which may reduce friction between its sliding surface 77 and the inner side 25 of the track 21. For instance, the slider 33 may comprise a polymeric material having a low coefficient of friction with the rubber of the track 21. For example, in some embodiments, the slider 33 may comprise a thermoplastic material (e.g., a Hifax® polypropylene). The slider 33 may comprise any other suitable material in other embodiments. For instance, in some embodiments, the sliding surface 77 of the slider 33 may comprise a coating (e.g., a polytetrafluoroethylene (PTFE) coating) that reduces friction between it and the inner side 25 of the track 21, while a remainder of the slider 33 may comprise any suitable material (e.g., a metallic material, another polymeric material, etc.).

While in embodiments considered above the sliding surface 77 is part of the slider 33 which is separate from and mounted to the rail 44, in other embodiments, the sliding surface 77 may be part of the rail 44. That is, the sliding surface 77 may be integrally formed (e.g., molded, cast, or machined) as part of the rail 44. For example, the sliding surface 77 may be part of the lower portion 63 of the rail 44.

In some embodiments, as shown in FIGS. 28, 29 and 34 to 36, the frame 23 may comprise an elongate reinforcement 95 that extends along at least part of the rail 44 and includes a reinforcing material 97 that is more rigid than the material 86 of the rail 44. This may lend reinforcement (e.g., rigidity) to the material 86 of the rail 44 such as to avoid overstressing the material 86 of the rail 44.

The reinforcing material 97 of the elongate reinforcement 95 may be significantly stiffer than the material 86 of the rail 44. For instance, a ratio of a modulus of elasticity (i.e., Young's modulus) of the reinforcing material 97 of the elongate reinforcement 95 over a modulus of elasticity of the material 86 of the rail 44 may be at least 1.5, in some cases at least 2, in some cases at least 5, in some cases at least 10, and in some cases even more.

In this embodiment, the reinforcing material 97 of the elongate reinforcement 95 is metallic material. For instance, the metallic material 97 may be an alloy steel. Any other suitable metal may be used (e.g., a titanium alloy). In other embodiments, the reinforcing material 97 of the elongate reinforcement 95 may be a polymeric material that is more rigid than the material 86 of the rail 44 (e.g., polyvinylchloride (PVC), polyethylene terephthalate (PET), a fiber-reinforced polymer).

In this embodiment, the elongate reinforcement 95 comprises a body 87 extending along the longitudinal direction of the snowmobile 10 and a plurality of locating openings 99₁-99_{N} disposed in the body 87. The elongate reinforcement 95 extends along a substantial portion of a length of the rail 44. For instance, the elongate reinforcement 95 may extend along at least a majority (i.e., a majority or an entirety) of the length of the rail 44. The locating openings 99₁-99_{N} are configured to reduce a weight of the elongate reinforcement 95 since the reinforcing material 97 may be denser than the material 86 of the rail 44. Moreover, the locating openings 99₁-99_{N} may allow to more easily locate the elongate reinforcement 95 relative to the rail 44 upon installing the elongate reinforcement 95. For instance, in this example of implementation, the rail 44 comprises a plurality of protrusions 101₁-101_{N} that have a shape (e.g., rounded rectangular) that matches a shape of the locating openings 99₁-99_{N} of the elongate reinforcement 95 such that a protrusion 101ᵢ of the plurality of protrusions 101₁-101_{N} can be inserted in a respective opening 99ᵢ of the elongate reinforcement 95.

The elongate reinforcement 95 also comprises axle-receiving openings for receiving respective axles of the lower roller wheels 28₁-28₄. The axle-receiving openings of the elongate reinforcement 95 are aligned with axle-receiving openings of the rail 44 such that the axles of the roller wheels (i.e., one axle for each pair of the lower roller wheels 28₁-28₄ that is aligned in the longitudinal direction of the track system 14) are received in the axle-receiving openings of the elongate reinforcement 95 and the axle-receiving openings of the rails 44. In this example, as there are two pairs of the lower roller wheels 28₁-28₄ that are aligned in the longitudinal direction of the track system 14, the elongate reinforcement 95 comprises two axle-receiving openings.

In order to secure the elongate reinforcement 95 to the rail 44, the elongate reinforcement also comprises a plurality of fastener-receiving openings 103₁-103_{N} for receiving a respective fastener 205 therein. More particularly, the fastener-receiving openings 103₁-103_{N} are through holes such that the fasteners 205 extend through the fastener-receiving openings 103₁-103_{N}. In such embodiments, the rail 44 comprises a plurality of fastener-engaging mounts 106₁-106_{N} for securedly engaging the fasteners 205. In this example, each of the fastener-engaging mounts 106₁-106_{N} comprises a threaded insert to threadedly engage a corresponding one of the fasteners 205.

In this embodiment, the frame 23 comprises two elongate reinforcements 95, one disposed on each lateral side of the rail 44. However, in some embodiments, the frame 23 may comprise a single elongate reinforcement 95.

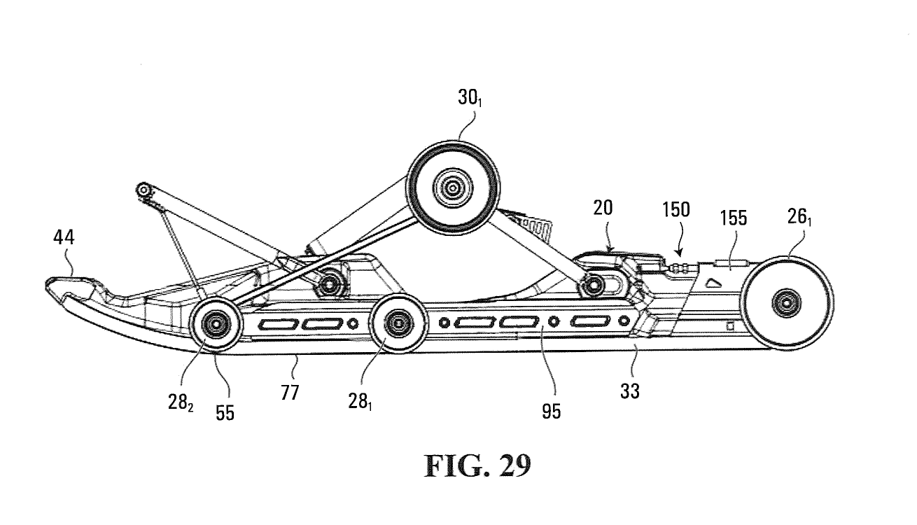

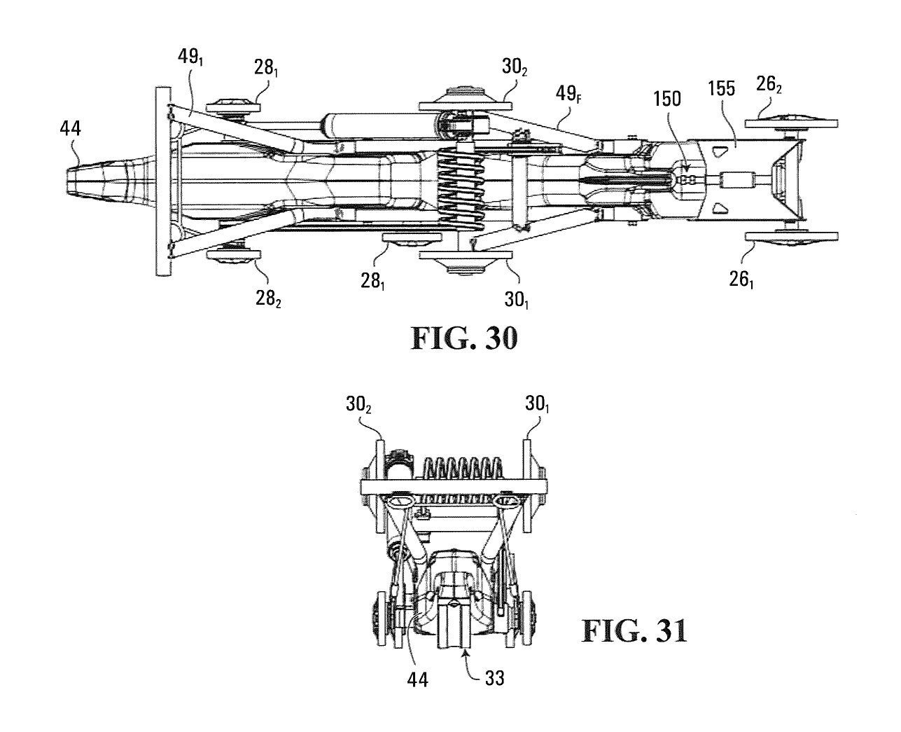

Moreover, as shown in FIGS. 29 and 30, in this example of implementation, the track system 14 comprises a tensioner 150 for tensioning the track 21. For instance, in this embodiment, the tensioner 150 comprises an actuator mounted at one end of the frame 23 of the track system 14 and at another end to a member 155 which supports an axle of the rear idler wheels 26₁, 26₂. This allows the tensioner 150 to modify a distance between the rear idler wheels 26₁, 26₂ and the roller wheels 28₁-28₄ in the longitudinal direction of the track system 14. A similar tensioner could be implemented in the embodiment of the track system 14 depicted in FIGS. 2 to 6.

A lower part 90 of the track-engaging assembly 24 comprises an interface 92 of the track-engaging assembly 24 with the bottom run 66 of the track 21. The interface 92 of the track-engaging assembly 24 with the bottom run 66 of the track 21 comprises surfaces of the track-engaging assembly 24 that are in contact with the bottom run 66 of the track 21, including, in this embodiment, a circumferential surface 94 of each of the idler wheels 26₁, 26₂, 28₁-28₆ and the sliding surface 77 of the elongate support 62.

The track system 14 is configured to enhance traction of the snowmobile 10 on the ground, including by maintaining proper engagement of the track 21 with the ground when the user leans (and possibly even stands) on a lateral side of the snowmobile 10 to adjust a course of the snowmobile 10 and/or stabilize the snowmobile 10 over uneven terrain and/or when the track system 14 is subject to other loading that would otherwise tend to reduce tractive forces generated by the track 21.

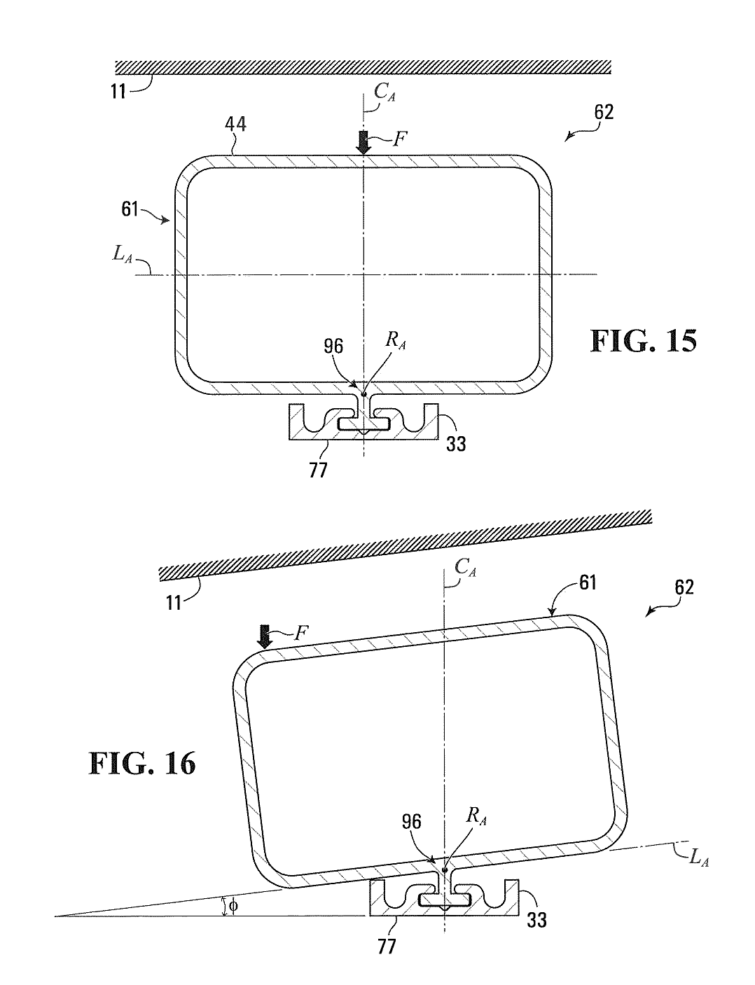

In this embodiment, with additional reference to FIGS. 15 and 16, the track system 14 is configured such that, when the snowmobile 10 travels on the ground, at least part of the interface 92 of the track-engaging assembly 24 with the bottom run 66 of the track 21 is movable relative to the frame 11 of the snowmobile 10 to change an orientation of one or more of the surfaces of the track-engaging assembly 24 that are in contact with the bottom run 66 of the track 21 (i.e., the circumferential surface 94 of each of the idler wheels 26₁, 26₂, 28₁-28₆ and the sliding surface 77 of the elongate support 62) relative to the frame 11 of the snowmobile 10. This relative movement may help to maintain proper engagement of the track 21 with the ground during maneuvers of the snowmobile 10 and/or under other loading conditions which would otherwise tend to reduce tractive forces generated by the track 21. For example, this relative movement may occur in response to leaning of the snowmobile 10 relative to the ground (e.g., when the user banks the snowmobile 10 to turn). Alternatively or additionally, this relative movement may occur in response to an unevenness of the ground 14 (e.g., a bump, obstacle or other change in ground level) in the widthwise direction of the track system 14.

More particularly, in this embodiment, the track system 14 is configured such that, when the snowmobile 10 travels on the ground, one or more of the surfaces of the track-engaging assembly 24 that are in contact with the bottom run 66 of the track 21 (i.e., the circumferential surface 94 of each of the idler wheels 26₁, 26₂, 28₁-28₆ and the sliding surface 77 of the elongate support 62) are rotatable relative to the frame 11 of the snowmobile 10 about a roll axis R_{A} substantially parallel to the longitudinal direction of the track system 14. That is, a surface of the track-engaging assembly 24 that is in contact with the bottom run 66 of the track 21 is movable relative to the frame 11 of the snowmobile 10 such that movement of that surface of the track-engaging assembly 24 relative to the frame 11 of the snowmobile 10 includes a rotation of that surface of the track-engaging assembly 24 relative to the frame 11 of the snowmobile 10 about the roll axis R_{A}.

This is achieved, in this embodiment, by the track system 14 being configured such that, when the snowmobile 10 travels on the ground, an upper part 91 of the track-engaging assembly 24 is movable relative to the lower part 90 of the track-engaging assembly 24 to change an orientation of the upper part 91 of the track-engaging assembly 24 relative to the lower part 90 of the track engaging assembly 24. In this example, the upper part 91 of the track-engaging assembly 24 is rotatable relative to the lower part 90 of the track-engaging assembly 24 about the roll axis R_{A}. That is, the upper part 91 of the track-engaging assembly 24 is movable relative to the lower part 90 of the track-engaging assembly 24 such that movement of the upper part 91 of the track-engaging assembly 24 relative to the lower part 90 of the track-engaging assembly 24 includes a rotation of the upper part 91 of the track-engaging assembly 24 relative to the lower part 90 of the track-engaging assembly 24 about the roll axis R_{A}.

Notably, in this embodiment, the track system 14 is configured such that, when the snowmobile 10 travels on the ground, the sliding surface 77 of the elongate support 62 is movable relative to the frame 11 of the snowmobile 10 to change an orientation of the sliding surface 77 relative to the frame 11 of the snowmobile 10. Thus, in this example, the sliding surface 77 is rotatable relative to the frame 11 of the snowmobile 10 about the roll axis R_{A}. That is, the sliding surface 77 is movable relative to the frame 11 of the snowmobile 10 such that movement of the sliding surface 77 relative to the frame 11 of the snowmobile 10 includes a rotation of the sliding surface 77 relative to the frame 11 of the snowmobile 10 about the roll axis R_{A}.

In this embodiment, the track system 14 is configured such that, when the snowmobile 10 travels on the ground, the upper portion 61 of the rail 44 is movable relative to the sliding surface 77 to change an orientation of the upper portion 61 of the rail 44 relative to the sliding surface 77. Thus, in this example, the upper portion 61 of the rail 44 is rotatable relative to the sliding surface 77 about the roll axis R_{A}. That is, the upper portion 61 of the rail 44 is movable relative to the sliding surface 77 such that movement of the upper portion 61 of the rail 44 relative to the sliding surface 77 includes a rotation of the upper portion 61 of the rail 44 relative to the sliding surface 77 about the roll axis R_{A}.

Movement of the upper portion 61 of the rail 44 relative to the sliding surface 77 may be implemented in any suitable way. Examples of how this may be achieved in various embodiments are discussed below.

### I. Resilient Deformation

In some embodiments, as shown in FIGS. 15 and 16, the track-engaging assembly 24 comprises a resiliently deformable area 96 that is resiliently deformable to allow movement of the upper part 91 of the track-engaging assembly 24 relative to the lower part 90 of the track-engaging assembly 24.

More particularly, in this embodiment, the lower portion 63 of the rail 44 is resiliently deformable to allow movement of the upper portion 61 of the rail 44 relative to the sliding surface 77. The resiliently deformable area 96 is thus part of the lower portion 63 of the rail 44 in this example.

The resiliently deformable area 96 may be implemented in various ways. For instance, the resiliently deformable area 96 may have a relatively low stiffness. More specifically, in this embodiment, the stiffness of the lower portion 63 of the rail 44 may be less than a stiffness of the upper portion 61 of the rail 44 (i.e., the lower portion 63 of the rail 44 is more flexible than the upper portion 61 of the rail 44).

In this embodiment, the lower portion 63 of the rail 44 comprises a resilient material 98 which provides compliance to the lower portion 63 of the rail 44. In this case, the resilient material 98 is the polymeric material 86 making up the rail 44, including the lower portion 63 of the rail 44. More specifically, the resilient material 98 of the lower portion 63 of the rail 44 is operable to deform from a first configuration to a second configuration in response to a load and recover the first configuration in response to removal of the load.

More particularly, in this embodiment, a modulus of elasticity (i.e., Young's modulus) of the resilient material 98 may be no more than 10 GPa, in some cases no more than 5 GPa, in some cases no more than 1 GPa, and in some cases even less (e.g., no more than 0.5 GPa). The modulus of elasticity of the resilient material 98 may have any other suitable value in other embodiments.

For instance, in some examples, the stiffness of the lower portion 63 of the rail 44 may be calculated, based on a minimal cross-section of the lower portion 63 of the rail 44 taken parallel to the longitudinal direction of the track system, as a product of (i) the modulus of elasticity of the material 98 of the lower portion 53 of the rail 44 at that minimal cross-section and (i) an area moment of inertia (i.e., a second moment of area) of the minimal cross-section of the lower portion 63 of the rail 44 with respect to an axis parallel to the longitudinal direction of the track system. For example, in some embodiments, the stiffness of the lower portion 63 of the rail 44 may be no more than 1.0E4 GPa/mm⁴, in some cases no more than 5.0E3 GPa/mm⁴, in some cases no more than 1.0E3 GPa/mm⁴, and in some cases even less (e.g., no more than 5.0E2 GPa/mm⁴). The stiffness of the lower portion 63 of the rail 44 may have any other suitable value in other embodiments.

In this embodiment, the rail 44 is a hollow structure. That is, the rail 44 comprises a hollow interior 68. More particularly, in this embodiment, the hollow interior 68 occupies a majority of a volume of the rail 44. The hollow interior 68 therefore occupies at least 50%, in some cases at least 65%, in some cases at least 80%, and in some cases an even greater proportion (e.g., at least 90% or 95%) of the volume of the rail 44. In other embodiments, the hollow interior 68 may occupy a smaller proportion of the volume of the rail 44. This hollowness of the rail 44 may help to facilitate resilient deformation of the rail 44 for movement of the upper portion 61 of the rail 44 relative to the sliding surface 77 as well as to reduce a weight of the track system 14. In this case, as further discussed later, the hollowness of the rail 44 is created during molding of the rail 44.

The hollow interior 68 is defined by a wall 29 of the rail 44. In this embodiment, the wall 29 encloses the hollow interior 68 such that the hollow interior 68 is closed. This prevents mud, rocks, debris and/or other undesirable ground matter from entering into the hollow interior 68 of the rail 44.

The wall 29 has a thickness suitable for providing sufficient rigidity to the rail 44. This depends on the material 86 making up the rail 44 and on loads to which the rail 44 is expected to be subjected to. For example, in some embodiments, the thickness of the wall 29 may be at least 1 mm, in some cases at least 3 mm, in some cases at least 5 mm, and in some cases at least 8 mm. For instance, in this example of implementation in which the wall 29 includes high-density polyethylene, the thickness of the wall 29 may be between 2 mm and 8 mm. In cases in which the thickness of the wall 29 varies such that it takes on different values in different regions of the rail 44, the thickness of the wall 29 may be taken as its minimum thickness. In other cases, the thickness of the wall 29 may be generally constant over an entirety of the rail 44.

The rail 44 may be manufactured in any suitable manner. In this embodiment, the rail 44 is molded into shape in a mold such that it is a molded structure. In particular, in this case, the hollowness and the upper and lower portions 61, 63 of the rail 44 are realized during molding of the rail 44.

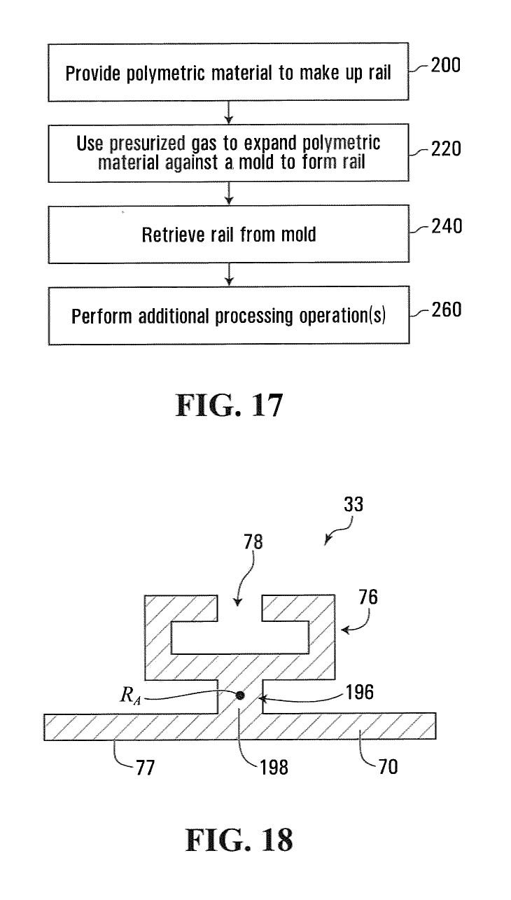

More specifically, in this embodiment, the rail 44 is blow-molded into shape such that it is a blow-molded structure. For instance, FIG. 17 is a flowchart illustrating an example of a blow-molding process used to mold the rail 44.

At step 200, the polymeric material 86 that will make up the rail 44 is provided. For instance, in some cases, the polymeric material 86 may be provided as a preform (also sometimes called “parison”), which is essentially a hot hollow tube of polymeric material. In other cases, the polymeric material 86 may be provided as one or more hot sheets.

At step 220, pressurized gas (e.g., compressed air) is used to expand the polymeric material 86 against a mold. The mold has an internal shape generally corresponding to the shape of the rail 44 such that, as it is expanded against the mold, the polymeric material 86 is shaped into the rail 44. In this embodiment, this creates a shape of the rail 44, including its hollow interior space 68. Pressure is held until the polymeric material 86 cools and hardens.

At step 240, once the polymeric material 86 has cooled and hardened, the rail 44 is retrieved from the mold.

At optional step 260, one or more additional operations (e.g., trimming) may be performed on the rail 44 which has been molded.

The rail 44 is thus constructed in this embodiment to enhance the performance of the track system 14. For example, owing to its polymeric material 86 that provides compliance and to its configuration, the resiliently deformable area 96 of the lower portion 63 of the rail 44 allows for movement of the upper portion 61 of the rail 44 relative to the sliding surface 77 when the snowmobile 10 travels. Also, due to the hollowness of the rail 44, the frame 23 may be voluminous yet lightweight, thus helping to contain the weight of the track system 14. As another example, by being voluminous, the rail 44 occupies space within the track system 14 which would otherwise be available for unwanted ground matter (i.e., snow, ice and/or other debris) to accumulate in, and, therefore, helps to reduce a potential for unwanted ground matter accumulation in the track system 14.

Although it is configured in a certain manner in this embodiment, the rail 44 may be configured in various other manners in other embodiments.

For example, while the rail 44 has a certain shape in this embodiment, the rail 44 may have any other suitable shape in other embodiments.

As another example, although in this embodiment the rail 44 is blow-molded, in other embodiments, the rail 44 may be manufactured using other manufacturing processes. For example, in some embodiments, the rail 44 may be manufactured by a rotational molding (sometimes also referred to as “rotomolding”) process in which a heated mold is filled with material and then rotated (e.g., about two perpendicular axes) to cause the material to disperse and stick to a wall of the mold. As another example, in some embodiments, the rail 44 may be manufactured by individually forming two or more pieces and then assembling these pieces together (e.g., individually forming two halves of the rail 44 and then assembling these two halves together; individually forming the upper and lower portions 61, 63 of the rail 44 and then assembling these pieces together; etc.). Such individual forming of two or more pieces may be effected by individually molding (e.g., by an injection or other molding process), extruding, or otherwise forming these two or more pieces. Such assembling may be effected by welding (e.g., sonic welding), adhesive bonding, using one or more fasteners (e.g., bolts, screws, nails, etc.), or any other suitable technique.

In this embodiment, the resiliently deformable area 96 defines the roll axis R_{A} about which the upper portion 61 of the rail 44 is rotatable relative to the sliding surface 77 of the elongate support 62. In other words, the upper portion 61 of the rail 44 is rotatable about the resiliently deformable area 96 and more specifically about the roll axis R_{A} which is substantially parallel to the longitudinal direction of the track system 14. The weight of the track system 14 is generally balanced in its widthwise direction about a central axis C_{A} bisecting a width of the rail 44 and extending through the roll axis R_{A} such that the central axis C_{A} is normal to the sliding surface 77 of the elongate support 62.

More particularly, in this embodiment, the rail 44 is operable to resiliently deform from a neutral configuration to a biased configuration and vice-versa. More specifically, with additional reference to FIG. 15, the rail 44 adopts the neutral configuration when the track system 14 is unloaded (i.e., when the rail 44 is not subjected to any load external to the track system 14) or centrally-loaded (i.e., the rail 44 is subjected to a net load F external to the track system 14 that is generally aligned with the central axis C_{A}). For example, the rail 44 may adopt the neutral configuration when a center of gravity of the user of the snowmobile 10 is generally aligned with respect to the central axis C_{A} (e.g., when the user is sitting up straight on the seat 18 of the snowmobile 10).

In the neutral configuration of the rail 44, a lateral axis L_{A} of the upper portion 61 of the rail 44 (i.e., an axis extending in a widthwise direction of the upper portion 61 of the rail 44) is generally orthogonal to the central axis C_{A} of the rail 44. In other words, in the neutral configuration, the lateral axis L_{A} is substantially parallel to the sliding surface 77 of the elongate support 62.

As shown in FIG. 16, the rail 44 transitions to the biased configuration in response to the net load F being offset from the central axis C_{A} of the rail 44. More specifically, as the net load F is offset from the central axis C_{A}, a bending moment is generated at the roll axis R_{A} which causes the rail 44 to deform and adopt the biased configuration. For example, the rail 44 may adopt the biased configuration when the center of gravity of the user is offset from the central axis C_{A} (e.g., when the user is leaning towards a lateral side of the snowmobile 10).

When the rail 44 transitions to the biased configuration, the orientation of the upper portion 61 of the rail 44 is changed relative to the sliding surface 77 of the elongate support 62. More specifically, the rail 44 transitions to the biased configuration through a rotation of the upper portion 61 of the rail 44 relative to the sliding surface 77 about the roll axis R_{A} by a roll angle φ (e.g., measured between the sliding surface 77 and the lateral axis L_{A} of the upper portion 61 of the rail 44). The roll angle φ may depend on the magnitude of the net load F and its distance from the central axis C_{A} of the rail 44 amongst other factors (e.g., elasticity of the resilient material 98 of the deformable area 96). For example, in some embodiments, the roll angle φ may be at least 5°, in some cases at least 10°, in some cases at least 15°, in some cases at least 20°, in some cases at least 25°, and in some cases even more.

The rotational motion of the upper portion 61 of the rail 44 about the roll axis R_{A} may enable the sliding surface 77 to substantially remain in contact with the inner side 25 of the track 21 to apply the bottom run 66 of the track 21 onto the ground on which the snowmobile 10 travels. This may enhance traction between the track 21 and the ground.

Once the net load F is substantially aligned with the central axis C_{A} of the rail 44 (or the rail 44 is no longer subjected to the net load F), the rail 44 transitions from the biased configuration to the neutral configuration. That is, the upper portion 61 of the rail 44 rotates about the roll axis R_{A} such that the lateral axis L_{A} of the upper portion 61 of the rail 44 is substantially parallel with the sliding surface 77.

Although the rail 44 is illustrated as being biased towards one lateral side of the track system 14, it will be appreciated that the rail 44 may be biased towards an opposite lateral side of the track system 14 when the net load F is applied on an opposite side of the central axis C_{A}. Moreover, although the net load F is depicted in the drawings as being applied at a location within a widthwise extent of the rail 44, this is merely to simplify the illustrations. In many cases, the net load F may be applied at a location in the widthwise direction of the track system 14 beyond the widthwise extent of the rail 44.

The upper portion 61 of the rail 44 may be configured to move relative to the sliding surface 77 of the elongate support 62 in any other suitable way in other embodiments.

For instance, in some embodiments, the slider 33 of the elongate support 62 may be configured to resiliently deform rather than the rail 44. More specifically, with additional reference to FIGS. 18 to 20, the slider 33 of the elongate support 62 may comprise a resiliently deformable area 196 that is resiliently deformable to allow movement of the mating portion 76 of the slider 33 relative to the base 70 of the slider 33. In view of its mating engagement with the rail 44, the resiliently deformable slider 33 allows movement of the rail 44, including the upper portion 61 of the rail 44, relative to the sliding surface 77 of the slider 33.

The resiliently deformable area 196 of the slider 33 may be implemented in any suitable way, including in a manner similar to that described above in respect of the resiliently deformable area 96 of the rail 44. For instance, the resiliently deformable area 196 may have a relatively low stiffness. More specifically, in some embodiments, the stiffness of the slider 33 may be less than the stiffness of the upper portion 61 of the rail 44 (i.e., the slider 33 may be more flexible than the upper portion 61 of the rail 44). For example, in some embodiments, the stiffness of the slider 33 may be no more than 1.0E4 GPa/mm⁴, in some cases no more than 5.0E3 GPa/mm⁴, in some cases no more than 1.0E3 GPa/mm⁴, and in some cases even less (e.g., no more than 5.0E2 GPa/mm⁴). The stiffness of the slider 33 may have any other suitable value in other embodiments.

More particularly, in this embodiment, the slider 33 comprises a resilient material 198 which provides compliance to the slider 33. More specifically, the resilient material 198 of the slider 33 is operable to deform from a first configuration to a second configuration in response to a load and recover the first configuration in response to removal of the load. For instance, in some embodiments, a modulus of elasticity of the resilient material 198 may be smaller than the modulus of elasticity of the polymeric material 86 of the rail 44. For example, in some embodiments, a modulus of elasticity of the resilient material 198 may no more than 10 GPa, in some cases no more than 5 GPa, in some cases no more than 1 GPa, and in some cases even less (e.g., no more than 0.5 GPa). The modulus of elasticity of the resilient material 198 may have any other suitable value in other embodiments.

In this example of implementation, the resilient material 198 of the slider 33 comprises a polymeric material. For instance, the resilient material 198 of the slider 33 may be a thermoplastic material (e.g., a Hifax® polypropylene). The resilient material 198 of the slider 33 may be any other suitable material in other examples of implementation.

In this embodiment, the resiliently deformable area 196 of the slider 33 defines the roll axis R_{A} about which the mating portion 76 of the slider 33, and consequently the upper portion 61 of the rail 44, is rotatable. In other words, the upper portion 61 of the rail 44 is rotatable about the resiliently deformable area 196 and more specifically about the roll axis R_{A} which is substantially parallel to the longitudinal direction of the track system 14. The weight of the track system 14 is generally balanced in its widthwise direction about the central axis C_{A} bisecting the width of the rail 44 and extending through the roll axis R_{A} such that the central axis C_{A} is normal to the sliding surface 77 of elongate support 62.

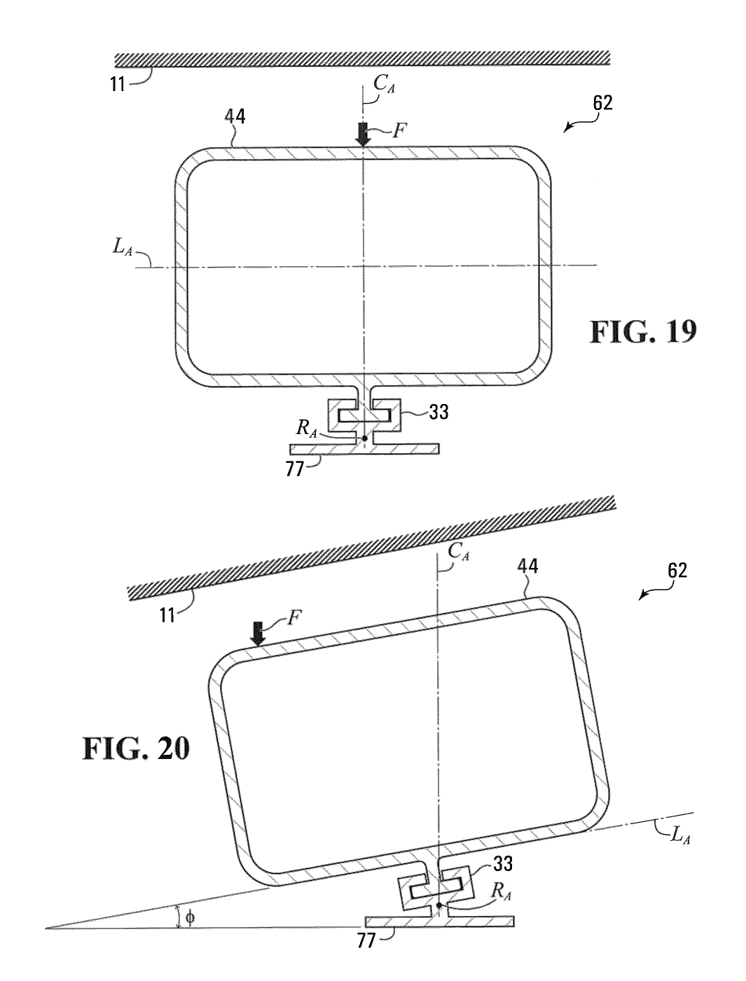

In this embodiment, the slider 33 is operable to resiliently deform from a neutral configuration to a biased configuration and vice-versa. As shown in FIG. 19, the slider 33 adopts the neutral configuration when the track system 14 is unloaded (i.e., the slider 33 is not subjected to any load external to the track system 14) or centrally-loaded (i.e., the slider 33 is subjected to the net load F that is generally aligned with the central axis C_{A} of the rail 44). In the neutral configuration of the slider 33, the rail 44 is in a first position in which the lateral axis L_{A} of its upper portion 61 is substantially parallel with the sliding surface 77 of the slider 33.

With additional reference to FIG. 20, the slider 33 transitions to the biased configuration in response to the net load F being offset from the central axis C_{A} of the rail 44. More specifically, as the net load F is offset from the central axis C_{A}, a bending moment is generated at the roll axis R_{A} which causes the slider 33 to deform and adopt the biased configuration.

When the slider 33 transitions to the biased configuration, the rail 44 (which is mateably engaged with the slider 33) is moved to a second position. More specifically, the rail 44, including the upper portion 61 of the rail 44, is rotated about the roll axis R_{A} relative to the sliding surface 77 by a roll angle θ (e.g., measured from the sliding surface 77 of the slider 33 to the lateral axis L_{A} of the rail 44). For example, in some embodiments, the roll angle θ may be at least 5°, in some cases at least 10°, in some cases at least 15°, in some cases at least 20°, in some cases at least 25°, and in some cases even more.

The rotational motion of the upper portion 61 of the rail 44 about the roll axis R_{A} may allow the slider 33 and its sliding surface 77 to substantially remain in place to apply the bottom run 66 of the track 21 onto the ground on which the snowmobile 10 travels. This may enhance traction between the track 21 and the ground.

Once the net load F is aligned with the central axis C_{A} of the slider 33 (or the slider 33 is no longer subjected to the net load F), the slider 33 again transitions from the biased configuration to the neutral configuration which causes the rail 44 to transition from the second position back to the first position. Although the slider 33 is illustrated as being biased towards one lateral side of the track system 14, it will be appreciated that the slider 33 may be biased towards an opposite lateral side of the track system 14 when the net load F is applied on an opposite side of the central axis C_{A}.

In some embodiments, the rail 44 may not be resiliently deformable since, through its compliance, the slider 133 causes the rail 44 to rotate about the roll axis R_{A}. Thus, in this embodiment, the rail 44 may comprise a non-resilient material, including metallic material, polymeric material, or any other suitable material. Moreover, the rail 44 may be manufactured in any suitable way.

In other embodiments, both the rail 44 and the slider 33 may be resiliently deformable (i.e., both the resiliently deformable area 96 of the rail 44 and the resiliently deformable area 196 of the slider 33 may be provided) so that the movement of the upper portion 61 of the rail 44 relative to the sliding surface 77 involves resilient deformations of the rail 44 and the slider 33.

### II. Movable Mechanical Joint

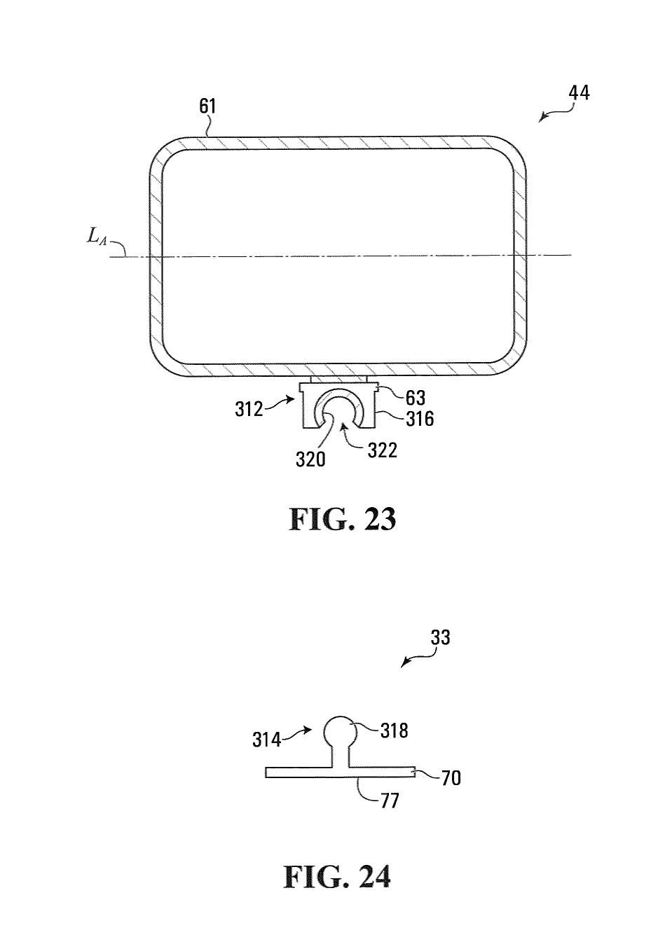

In some embodiments, as shown in FIGS. 23 to 26, the track-engaging assembly 24 comprises a movable mechanical joint 300 between the upper part 91 of the track-engaging assembly 24 and the lower part 90 of the track-engaging assembly 24 to allow movement of the upper part 91 of the track-engaging assembly 24 relative to the lower part 90 of the track-engaging assembly 24.

More particularly, in this embodiment, the movable mechanical joint 300 is between the upper portion 61 of the rail 44 and the sliding surface 77 to allow movement of the upper portion 61 of the rail 44 relative to the sliding surface 77. In this example, the movable mechanical joint 300 is between the rail 44 and the slider 33.

In this embodiment, the movable mechanical joint 300 comprises a pivot 310 to allow pivoting of the upper portion 61 of the rail 44 relative to the sliding surface 77.

The pivot 310 may be implemented in any suitable way. For instance, in this embodiment, the pivot 310 comprises a connection between the lower portion 63 of the rail 44 and the slider 33. More particularly, in this embodiment, the lower portion 63 of the rail 44 comprises a first engaging member 312 that is configured to engage a second engaging member 314 of the slider 33 such that the first engaging member 312 is movable relative to the second engaging member 314. The connection between the first and second engaging members 312, 314 defines the roll axis R_{A} about which the upper portion 61 of the rail 44 is pivotable.

As shown in FIGS. 23 and 24, in this embodiment, the first engaging member 312 comprises a housing 316 and the second engaging member 314 comprises a circular stud 318, the housing 316 being configured to receive the circular stud 318. The housing 316 of the first engaging member 312 comprises a bearing 320 (e.g., a polymer bearing) defining a cavity 322 configured to securely receive the circular stud 318. The circular stud 318 is thus rotatable within the cavity 322 against the bearing 320.

In this embodiment, the roll axis R_{A} is located at a center of the circular stud 318 and is substantially parallel to the longitudinal direction of the track system 14. A central axis C_{A}′ of the pivot 310 extends through the roll axis R_{A} and is normal to the sliding surface 77 of the slider 33.

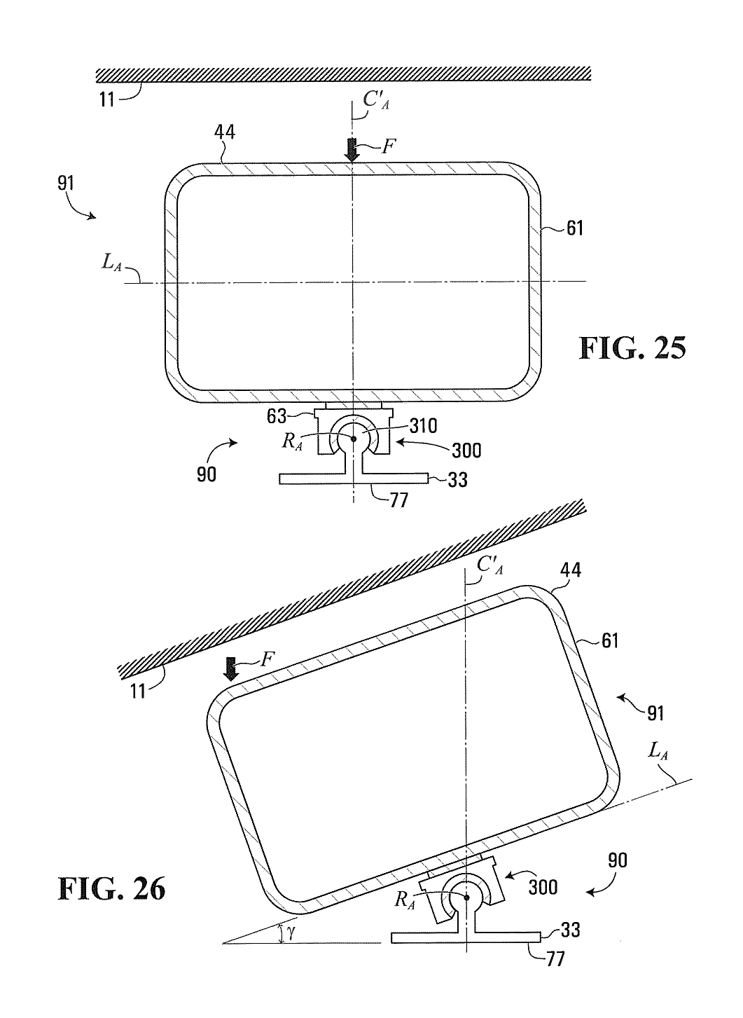

The upper portion 61 of the rail 44 is rotatable from a neutral position to an inclined position and vice-versa. More specifically, with additional reference to FIG. 25, the upper portion 61 of the rail 44 adopts the neutral position when the track system 14 is centrally-loaded (i.e., the rail 44 is subjected to a net load F external to the track system 14 that is generally aligned with the central axis C_{A}′). For example, the upper portion 61 of the rail 44 is in the neutral position when a center of gravity of the user of the snowmobile 10 is generally aligned with respect to the central axis C_{A}′ (e.g., when the user is sitting up straight on the seat 18 of the snowmobile 10).

In the neutral position, the lateral axis L_{A} of the upper portion 61 of the rail 44 is generally orthogonal to the central axis C_{A}′. In other words, in the neutral position, the lateral axis L_{A} is substantially parallel to the sliding surface 77 of the slider 33.

As shown in FIG. 26, the upper portion 61 of the rail 44 transitions to the inclined position in response to the net load F being offset from the central axis C_{A}′. More specifically, as the net load F is offset from the central axis C_{A}′, a moment is generated at the roll axis R_{A} which causes the upper portion 61 of the rail 44 to move to the inclined position. For example, the upper portion 61 of the rail 44 may adopt the inclined position when the center of gravity of the user is offset from the central axis C_{A}′ (e.g., when the user is leaning towards the side of the snowmobile 10).

When the upper portion 61 of the rail 44 moves to the inclined position, the orientation of the upper portion 61 of the rail 44 is changed relative to the sliding surface 77 of the elongate support 62. More specifically, the upper portion 61 of the rail 44 transitions to the inclined position through a rotation of the upper portion 61 of the rail 44 relative to the sliding surface 77 about the roll axis R_{A} by a roll angle α (e.g., measured from the sliding surface 77 of the slide rail 33 to the lateral axis L_{A} of the upper portion 61 of the rail 44). The roll angle α may depend on the magnitude of the net load F and its distance from the central axis C_{A}′ amongst other factors. For example, in some embodiments, the roll angle α may be at least 5°, in some cases at least 10°, in some cases at least 15°, in some cases at least 20°, in some cases at least 25°, and in some cases even more.

The rotational motion of the upper portion 61 of the rail 44 about the roll axis R_{A} may enable the slider 33 and its sliding surface 77 to substantially remain in contact with the inner side 25 of the track 21 to apply the bottom run 66 of the track 21 onto the ground matter on which the snowmobile 10 travels. This may enhance traction between the track 21 and the ground.

Once the net load F is substantially aligned with the central axis C_{A}′, the upper portion 61 of the rail 44 moves from the inclined position to the neutral position. That is, the upper portion 61 of the rail 44 rotates about the roll axis R_{A} such that the lateral axis L_{A} of the rail 44 substantially parallel with the sliding surface 77 of the slider 33.

Although the upper portion 61 of the rail 44 is illustrated as being moved towards one lateral side of the track system 14, it will be appreciated that the upper portion 61 of the rail 44 may be moved towards an opposite lateral side of the track system 14 when the net load F is applied on an opposite side of the central axis C_{A}′. Moreover, although the net load F is depicted in the drawings as being applied at a location within a widthwise extent of the rail 44, this is merely to simplify the illustrations. In many cases, the net load F may be applied at a location in the widthwise direction of the track system 14 beyond the widthwise extent of the rail 44.

In this embodiment, the rail 44 and the slider 33 may comprise any suitable material (e.g., metallic material, polymeric material, etc.) since neither the rail 44 nor the slider 33 needs to be resiliently deformable. In some embodiments, the rail 44 and/or the slider 33 may comprise resilient material as discussed above to be resiliently deformable, in addition to motion allowed by the movable mechanical joint 300.

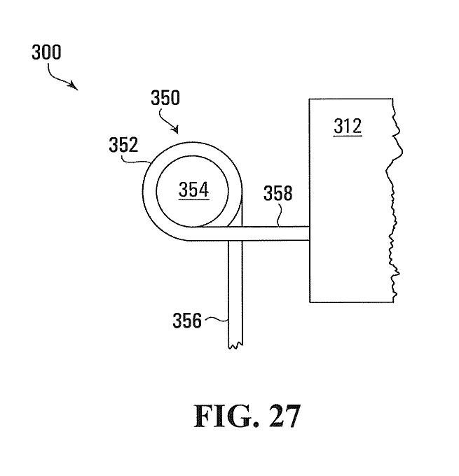

In some embodiments, with additional reference to FIG. 27, the movable mechanical joint 300 of the track-engaging assembly 24 may comprise a resilient device 350 for biasing the orientation of the upper portion 61 of the rail 44 relative to the sliding surface 77 towards a predetermined orientation. The resilient device 350 comprises a spring 352. The spring 352 may be a coil spring, a torsion spring, a leaf spring, an elastomeric spring (e.g., a rubber spring), a fluid spring (e.g., an air spring), or any other object that is operable to change in configuration from a first configuration to a second configuration in response to a load and recover the first configuration in response to removal of the load.

For example, in this embodiment, the spring 352 of the resilient device 350 may comprise a torsion spring mounted on a pin 354 which is connected to the slider 33 (not shown in FIG. 27). The spring 352 comprises first and second ends 356, 358 which are respectively connected to the slider 33 and the rail 44. More specifically, the first end 356 of the spring 352 may be connected to the base 70 of the slider 33 while the second end 358 of the spring 352 may be connected to the first engaging member 312 of the lower portion 63 of the rail 44 (e.g., to the housing 316).

Thus, when the upper portion 61 of the rail 44 moves to its inclined position (as illustrated in FIG. 26), the first engaging member 312 of the rail 44 rotates about the roll axis R_{A} and moves the second end 358 of the spring 352 such as to cause a bending moment at the spring 352. The spring 352 resists this movement by applying a force proportional to a stiffness of the spring 352 on the first engaging member 312 via the second end 358. The force applied by the spring 352 on the first engaging member 312 tends to bias the orientation of the upper portion 61 of the rail 44 relative to the sliding surface 77 towards a predetermined orientation which in this case coincides with the neutral position of the upper portion 61 of the rail 44 (i.e., when the lateral axis L_{A} is substantially parallel to the sliding surface 77 of the slider 33).

The resilient device 350 may thus aid the user of the snowmobile 10 in centering his/her body mass relative to the snowmobile 10 such that his/her center of gravity is substantially aligned with the central axis C_{A}′. More specifically, the stiffness of the spring 352 may not be sufficient to stop the user from changing the orientation of the upper portion 61 of the rail 44 when he/she offsets his/her center of gravity from the central axis C_{A}′, but the spring 352 may facilitate the movement of the upper portion 61 of the rail 44 towards its neutral position (i.e., when the lateral axis L_{A} is substantially parallel to the sliding surface 77 of the slider 33) when the user wishes to reorient the upper portion 61 of the rail 44 towards the neutral position.

The resilient device 350 may comprise another spring similar to the spring 352 on an opposite lateral side of the rail 44 to have a similar effect on movement of the upper portion 61 of the rail 44 relative to the sliding surface 77 towards the opposite side of the track system 14.

Movement of the upper portion 61 of the rail 44 relative to the sliding surface 77 may be implemented in any other suitable way in other embodiments.

Although embodiments considered above relate to movement of the upper portion 61 of the rail 44 relative to the sliding surface 77, principles disclosed herein may be applied to other components of the interface 92 of the track-engaging assembly 24 with the bottom run 66 of the track 21 such that, when the snowmobile 10 travels on the ground, an orientation of one or more other surfaces of the track-engaging assembly 24 that are in contact with the bottom run 66 of the track 21, such as the circumferential surface 94 of each of one or more of the idler wheels 26₁, 26₂, 28₁-28₆, relative to the frame 11 of the snowmobile 10 is variable.

For example, in some embodiments, the circumferential surface 94 of each of one or more of the idler wheels 26₁, 26₂, 28₁-28₆ may be rotatable relative to the frame of the 11 of the snowmobile 10 about the roll axis R_{A} due to compliance of the polymeric material 86 of the rail 44 (e.g., which has been blow-molded) that provides some “give” allowing a change in orientation of the axle of each of these one or more idler wheels relative to the frame 11 of the snowmobile 10 (i.e., (i.e., deformation of the polymeric material 86 around the idler wheel's axle). For instance, in some embodiments, the polymeric material 86 of the rail 44 may deform to allow an angular displacement of the axle of the idler wheel relative to the frame 11 of the snowmobile 10 of at least 5°, in some cases at least 10°, in some cases at least 15°, in some cases at least 20°, and in some cases even more. In some examples, this may allow a linear displacement of the axle of the idler wheel relative to the frame 11 of the snowmobile 10 of at least 5 mm, in some cases at least 10 mm, and in some cases even more.

The track system 14 may be implemented in any other suitable way in other embodiments.

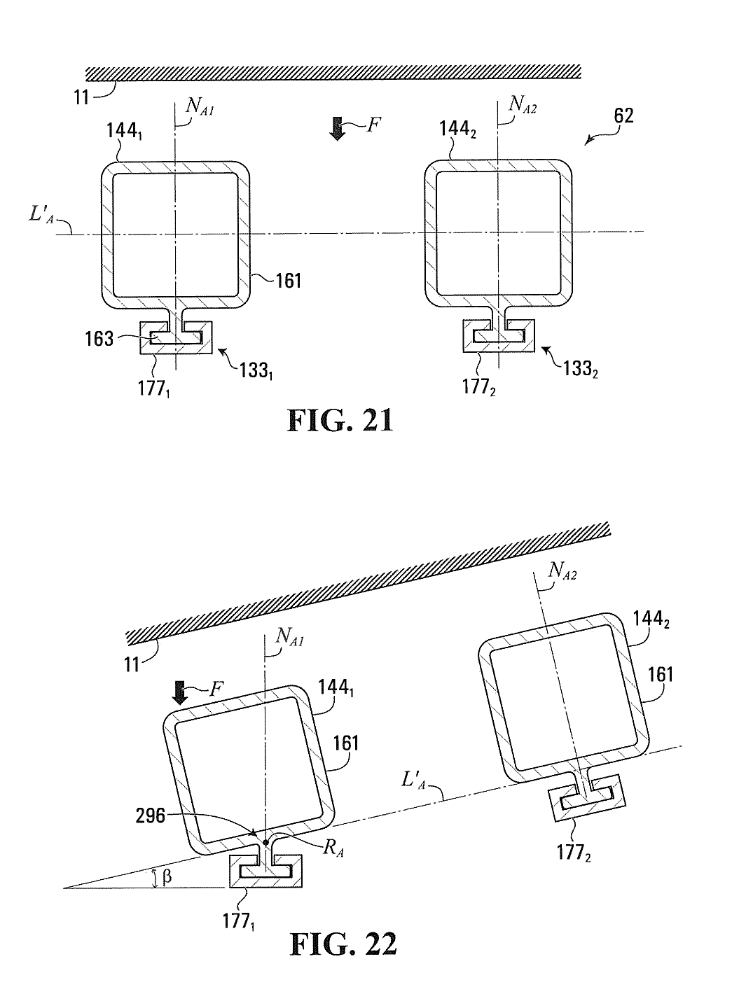

For example, in some embodiments, as shown in FIGS. 21 and 22, the elongate support 62 of the frame 23 of the track system 14 may comprise a plurality of rails 144₁, 144₂ that are spaced apart in the widthwise direction of the track system 14 and a plurality of sliding surfaces 177₁, 177₂ that are spaced apart in the widthwise direction of the track system 14. In this embodiment, when the snowmobile 10 travels on the ground, an upper portion 161 of each rail 144ᵢ is movable relative to a sliding surface 177ᵢ below it in order to change an orientation of the upper portion 161 of the rail 144ᵢ relative to the sliding surface 177ᵢ, similarly to what was discussed previously.

In this example, the rail 144ᵢ is mateably engaged with a corresponding slider 133; of a plurality of sliders 133₁, 133₂ via an interlocking portion of the rail 144ᵢ. Each slider 133; comprises a sliding surface 177ᵢ of the plurality of sliding surfaces 177₁, 177₂. In other embodiments, the sliders 133₁, 133₂ may be made integrally with the rails 144₁, 144₂ such that the sliding surfaces 177₁, 177₂ are part of the rails 144₁, 144₂.

In this embodiment, the plurality of rails 144₁, 144₂ are linked via structural members (not shown) such that the plurality of rails 144₁, 144₂, together, support axles of the idler wheels 26₁, 26₂, 28₁-28₆.

In this embodiment, a resiliently deformable area 296 of each rail 144ᵢ defines the roll axis R_{A} about which the upper portion 161 of the rail 144ᵢ is rotatable. In other words, the upper portion 161 of the rail 144ᵢ is rotatable about the resiliently deformable area 296 of the rail 144ᵢ and more specifically about the roll axis R_{A} which is substantially parallel to the longitudinal direction of the track system 14. The resiliently deformable area 296 may be implemented in a manner similar to that described above in respect of the resiliently deformable area 96. The weight of the track system 14 is balanced in its widthwise direction between normal axes N_{A1}, N_{A2} of respective ones of the rails 144₁, 144₂, each normal axis N_{Ai} extending through a corresponding roll axis R_{A} such that the normal axis N_{Ai} is normal to a corresponding sliding surface 177ᵢ.

Each rail 144ᵢ is operable to resiliently deform from a neutral configuration to a biased configuration and vice-versa. More specifically, with additional reference to FIG. 21, the rail 144ᵢ adopts the neutral configuration when the track system 14 is unloaded (i.e., when the elongate support 62 is not subjected to any load external to the track system 14) or centrally-loaded (i.e., the elongate support 62 is subjected to a net load F external to the track system 14 and applied at a location between the normal axes N_{A1}, N_{A2} or coinciding with one of the normal axes N_{A1}, N_{A2} of the rails 144₁, 144₂). For example, the rail 144ᵢ may adopt the neutral configuration when the center of gravity of the user of the snowmobile 10 is located between the normal axes N_{A1}, N_{A2} of the rails 144₁, 144₂ (e.g., when the user is sitting up straight on the seat 18 of the snowmobile 10).

In the neutral configuration, a lateral axis L_{A}′ of the upper portion 161 of each of the rails 144₁, 144₂ (i.e., an axis extending in a widthwise direction of the upper portion 161 of each of the rails 144₁, 144₂) is generally orthogonal to the normal axes N_{A1}, N_{A2} of the rails 144₁, 144₂. In other words, in the neutral configuration, the lateral axis L_{A}′ is substantially parallel to the sliding surfaces 177₁, 177₂ of the sliders 133₁, 133₂.

As shown FIG. 22, at least one rail 144ᵢ of the plurality of rails 144₁, 144₂ transitions to the biased configuration in response to the net load F being applied at a location not between the normal axes N_{A1}, N_{A2}. More specifically, as the net load F is moved to a location not between the normal axes N_{A1}, N_{A2}, a bending moment is generated at the roll axis R_{A} of the rail 144ᵢ closest to the location of the net load F which causes the rail 144ᵢ to deform and adopt the biased configuration. For example, the rail 144ᵢ adopts the biased configuration when the center of gravity of the user is applied at a location not between the normal axes N_{AI}, N_{A2} of the elongate support 62 (e.g., when the user is leaning towards the side of the snowmobile 10).

When the rail 144ᵢ transitions to the biased configuration, an orientation of the upper portion 161 of the rail 144ᵢ is changed relative to the sliding surface 177ᵢ of the corresponding slider 133ᵢ More specifically, the rail 144ᵢ transitions to the biased configuration through a rotation of the upper portion 161 of the rail 144ᵢ relative to the sliding surface 177 about the roll axis R_{A} by a roll angle β (e.g., measured between the sliding surface 177ᵢ and the lateral axis L_{A}′ of the upper portion 161 of the rail 144ᵢ). The roll angle β may depend on the magnitude of the net load F and its distance from the normal axis N_{Ai} of the rail 144ᵢ amongst other factors (e.g., elasticity of a resilient material of the rail 144ᵢ). For example, in some embodiments, the roll angle β may be at least 5°, in some cases at least 10°, in some cases at least 15°, in some cases at least 20°, in some cases at least 25°, and in some cases even more.

In the example shown in FIG. 22, the rail 144₁ resiliently deforms since the net load F is applied at a location not between the normal axes N_{A1}, N_{A2} and closest to the rail 144₁. As illustrated, while the motion of the lateral axis L_{A}′ of the elongate support 62 relative to the sliding surface 177₁ may cause the sliding surface 177₂ to lose contact with the inner side 25 of the track 21, it may also enable the slider 133₁ and its sliding surface 177₁ to substantially remain in contact with the inner side 25 of the track 21 to apply the bottom run 66 of the track 21 onto the ground matter on which the snowmobile 10 travels. This may enhance traction between the track 21 and the ground compared to prior art track systems comprising a plurality of rails.

Once the net load F is applied at a location between the normal axes N_{A1}, N_{A2} (or the elongate support 62 is no longer subjected to the net load F), the rail 144ᵢ transitions from the biased configuration to the neutral configuration.

Although the rail 144₁ is illustrated as being biased in FIG. 22, it will be appreciated that the rail 144₂ may equally be biased when the net load F is applied on an opposite lateral side of the track system 14 at a location not between the normal axes N_{A1}, N_{A2}. Moreover, although the net load F is depicted in the drawings as being applied at a location within a widthwise extent of the elongate support 62, this is merely to simplify the illustrations. In many cases, the net load F may be applied at a location in the widthwise direction of the track system 14 beyond the widthwise extent of the elongate support 62.

In a variant, each slider 133ᵢ may be configured similarly to the resiliently deformable slider 33 described above. For instance, in such a variant, the slider 133ᵢ may be resiliently deformable to transition from a neutral configuration to a biased configuration thus enabling the corresponding rail 144ᵢ to rotate about a roll axis of the slider 133ᵢ. In such cases, the rails 144₁, 144₂ may comprise any suitable material (e.g., metallic material, polymeric material, etc.).

While in this embodiment the track system 14 is part of the snowmobile 10, in other embodiments, a track system constructed according to principles discussed herein may be used as part of other types of off-road vehicles.

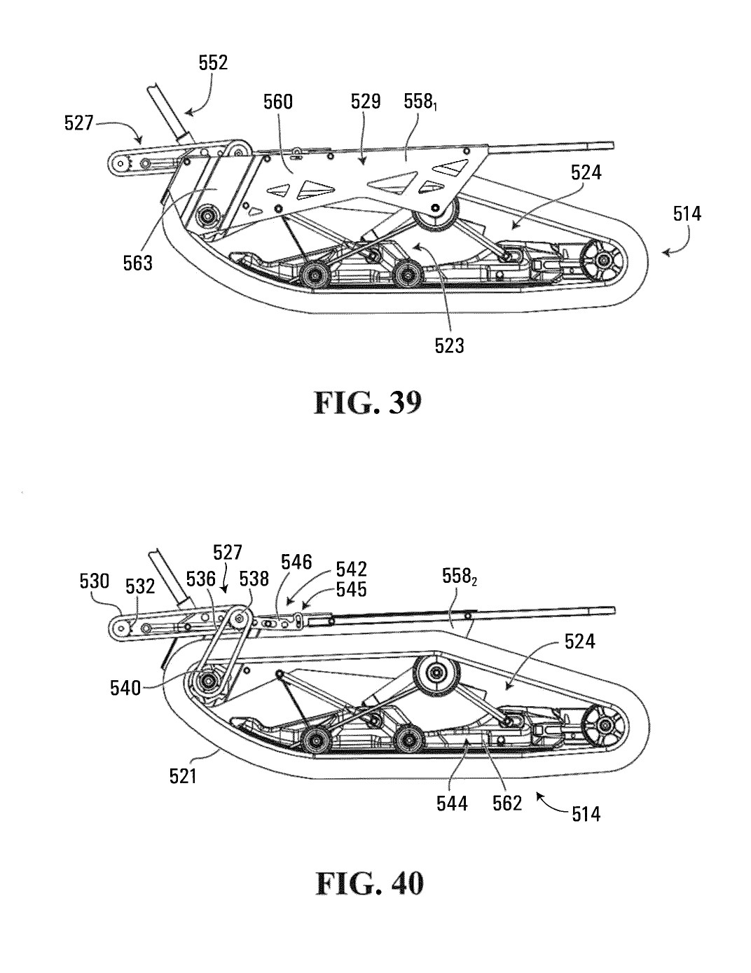

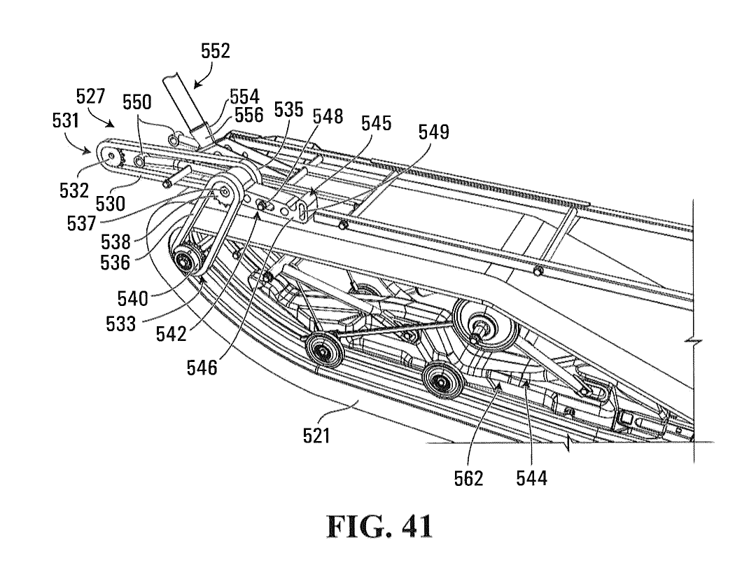

For example, in some embodiments, as shown in FIGS. 38 to 46 a track system 514 including a track 521 constructed according to principles discussed herein may be used as part of a snow bike 510. The snow bike 510 comprises a frame 511, a powertrain 512, a ski system 517, the track system 514, a seat 518, and a user interface 520 which enables a user to ride, steer and otherwise control the snow bike 510. The snow bike 510 has a length, a width, and a height that respectively define a longitudinal direction, a widthwise direction, and a heightwise direction of the snow bike 510.

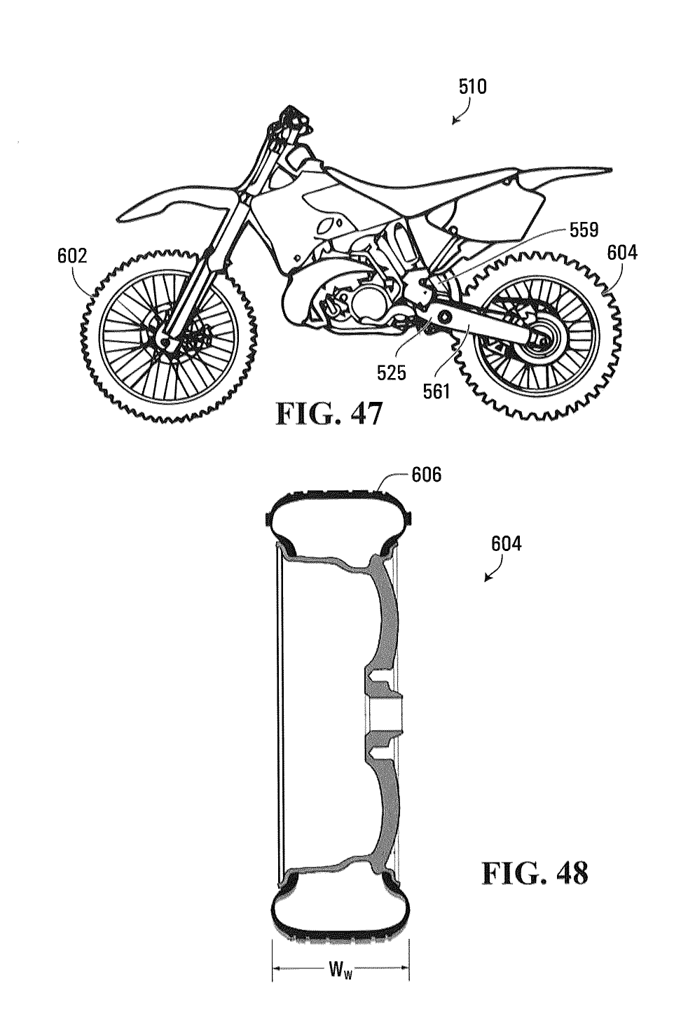

In this embodiment, with additional reference to FIG. 47, the snow bike 510 is a motorcycle equipped with the ski system 517 mounted in place of a front wheel 602 of the motorcycle and the track system 514 mounted in place of a rear wheel 604 of the motorcycle. In this example, the track system 514 also replaces a rear suspension unit 525 (e.g., a shock absorber 559 and a swing arm 561) of the motorcycle. Basically, in this embodiment, the ski system 517 and the track system 514 are part of a conversion system 513 that converts the motorcycle into a skied and tracked vehicle for travelling on snow.

As further discussed below, in this embodiment, the ski system 517 and the track system 514 are designed to enhance travel of the snow bike 510 on the ground, including to facilitate banking of the snow bike 510 (e.g., to turn, on a side hill, etc.), steering of the snow bike 510 by turning the ski system 14, and/or moving on harder snow (e.g., packed snow).

The powertrain 512 is configured for generating motive power and transmitting motive power to the track system 514 to propel the snow bike 510 on the ground. To that end, the powertrain 512 comprises a prime mover 515, which is a source of motive power that comprises one or more motors (e.g., an internal combustion engine, an electric motor, etc.). For example, in this embodiment, the prime mover 515 comprises an internal combustion engine. In other embodiments, the prime mover 515 may comprise another type of motor (e.g., an electric motor) or a combination of different types of motor (e.g., an internal combustion engine and an electric motor). The prime mover 515 is in a driving relationship with the track system 514. That is, the powertrain 512 transmits motive power from the prime mover 515 to the track system 514 in order to drive (i.e., impart motion to) the track system 514.

The seat 518 accommodates the user of the snow bike 510. In this case, the seat 518 is a straddle seat and the snow bike 510 is usable by a single person such that the seat 518 accommodates only that person driving the snow bike 510. In other cases, the seat 518 may be another type of seat, and/or the snow bike 510 may be usable by two individuals, namely one person driving the snow bike 510 and a passenger, such that the seat 518 may accommodate both of these individuals (e.g., behind one another).

The user interface 520 allows the user to interact with the snow bike 510 to control the snow bike 510. More particularly, in this embodiment, the user interface 520 comprises an accelerator, a brake control, and a steering device comprising handlebars 522 that are operated by the user to control motion of the snow bike 510 on the ground. The user interface 520 also comprises an instrument panel (e.g., a dashboard) which provides indicators (e.g., a speedometer indicator, a tachometer indicator, etc.) to convey information to the user.

The ski system 517 is disposed in a front 524 of the snow bike 510 to engage the ground and is turnable to steer the snow bike 510. To that end, the ski system 14 is turnable about a steering axis 526 of the snow bike 10. As shown in FIG. 38, the ski system 14 comprises a ski 528 to slide on the snow and a ski mount 530 that connects the ski 28 to a front steerable member 532 of the snow bike 510. In this embodiment where the snow bike 510 is a motorcycle and the ski system 14 replaces the front wheel 602 of the motorcycle, the front steerable member 532 comprises a front fork 534 of the snow bike 510 that would otherwise carry the front wheel 602.

The ski 528 is a sole ski of the snow bike 510. That is, the snow bike 510 has no other ski. Notably, the ski 528 is disposed in a center of the snow bike 510 in a widthwise direction of the snow bike 510. In this embodiment in which the snow bike 510 is a motorcycle and the ski system 517 replaces the front wheel 602 of the motorcycle, the ski 528 contacts the ground where the front wheel 602 would contact the ground.

In this embodiment, the track system 514 comprises a mounting arrangement 519 to mount the track system 514 to the motorcycle 510. More particularly, in this embodiment, the mounting arrangement 519 comprises a transmission 527 for transmitting power from the powertrain 512 of the snow bike 510 to drive wheels 522₁, 522₂ of a track-engaging assembly 524 of the track system 514, and a subframe 529 for interconnecting a frame 523 of the track-engaging assembly524 and the frame 511 of the snow bike 510.

In this example, with reference to Figures the transmission 527 comprises an input transmission portion 531 and an output transmission portion 533. The input transmission portion 531 comprises wheels 532, 535 and an elongated transmission link 530 for transmitting motion between the wheel 532 and the wheel 535. The wheel 532 of the input transmission portion 531 is configured to be rotated by power from the powertrain 512 of the snow bike 510 (e.g., mounted to a driven axle of the powertrain 512). The output transmission portion 533 comprises wheels 538, 540 and an elongated transmission link 536 for transmitting motion between the wheel 538 and the wheel 540. The wheel 540 is configured to rotate the drive wheels 522₁, 522₂ of the track system 514 (e.g., mounted to an axle to which the drive wheels 522₁, 522₂ are mounted). The wheel 535 of the input transmission portion 531 and the wheel 538 of the output transmission portion 533 are mounted on a floating axle 537 which defines an axis of rotation 539 that is common to both of the wheels 535, 538. In this case, each of the elongate transmission links 530, 536 is a chain and each of the wheels 532, 535, 538, 540 is a sprocket. The elongate transmission links 530, 536 and/or the wheels 532, 535, 538, 540 may be implemented in any other suitable way in other embodiments (e.g., transmission belts).

In this embodiment, the mounting arrangement 519 of the track system 514 comprises a tensioner 542 for adjusting a tension in each of the chains 530, 536. In this example, the tensioner 542 is configured to simultaneously adjust the tension in each of the chains 530, 536.

More particularly, in this embodiment, the tensioner 542 comprises an actuator 545 movable in response to a command to adjust the tension in each of the chains 530, 536. In this example, the actuator 545 is manually operable by a user such that the command can be provided by the user by manually operating the actuator 545.

The actuator 545 may be implemented in any suitable way. For example, in this embodiment, the actuator 545 comprises a lever 546 carrying the sprockets 535, 538 and movable relative to the frame 523 of the track system 514 to change a position of the sprockets 535, 538 relative to the sprockets 532, 540. More particularly, the lever 546 comprises a proximal end portion 541 from which the lever 546 may be grasped and a distal end portion 543 receiving the floating axle 537 (e.g., via a bearing) which supports the sprockets 535, 538. The lever 546 also comprises a first opening 547 between the proximal and distal end portions 541, 543 and a second opening 549 at the proximal end portion 541. The first opening 547 receives therein a fixed axle 551 of the subframe 529 that extends in the widthwise direction of the track system 514. The second opening 549 is configured to receive a fastener 553 for affixing the lever 546 to the subframe 529.

The floating axle 537 is selectively movable via actuation of the lever 546. In particular, when the fastener 553 is loosened from engagement with a corresponding fastening element (e.g., a nut), the lever 546 is pivotable about a pivot 548 defined by the fixed axle 551 and having a pivot axis 557. This allows the floating axle 537, which is supported at the distal portion 543 of the lever 546, to pivot about the pivot axis 557. In this example, the second opening 549 of the lever 232 is a slot (e.g., an arcuate slot) in order to allow the proximal end portion 541 of the lever 546 to be secured to the subframe 529 once the lever 546 has been pivoted.

The floating axle 537 may also be displaced linearly by the lever 546. More specifically, the first opening 547 of the lever 546 can be a slot extending in a longitudinal direction of the lever 546 such that the lever 546 can be displaced linearly through the engagement of the fixed axle 551 with the slot 547 of the lever 546. In this case, an opening in an elongated lateral member of the subframe 529 which receives therein the fastener 553 may be configured as a slot that extends in the longitudinal direction of the track system 514.

The pivoting and linear motions of the floating axle 537 allows selectively moving the floating axle 537 and therefore the sprockets 535, 538 closer to or further from the sprockets 532, 540. This movement of the sprockets 535, 538 induces a change in the tension of each of the chains 530, 536 that can be effected simultaneously.

In other embodiments, the actuator 545 may comprise any other type of actuator. For instance, in some embodiments, the actuator 545 may comprise an electromechanical actuator (e.g., a linear actuator) or a fluidic actuator (e.g., a hydraulic or pneumatic actuator). Also, in other embodiments, the command for moving the actuator 545 may be generated automatically (e.g., by a sensor sensing that the tension is inappropriate and is to be changed).

The subframe 529 of the mounting arrangement 519 comprises a plurality of links 550, 552 between the frame 523 of the track system 514 and the frame 511 of the motorcycle 510. In this embodiment, the link 550 pivotally interconnects the frame 523 of the track system 514 and the frame 511 of the motorcycle 510 (to allow vertical movement of the frame 523 of the track system 514 relative to the frame 511 of the motorcycle 510. In this case, the link 550 pivotally interconnects the frame 523 of the track system 514 and the frame 511 of the motorcycle 510 at a pivot axis 565 of the frame 511 of the motorcycle 510 at which the swing arm 561 of the motorcycle 510 would be connected. The link 552 extends between the frame 523 of the track system 514 and a mount 555 on the frame 511 of the motorcycle 510 at which the shock absorber 559 of the motorcycle's rear suspension unit 525 would be connected.

In this embodiment, the link 552 is resiliently deformable (i.e., changeable in configuration) to allow the frame 523 of the track system 514 to move relative to the frame 511 of the motorcycle 510. This may help to absorb shocks and/or otherwise improve ride comfort. More particularly, the link 552 comprises a resilient element 554 that is configured to resiliently deform (i.e., change in configuration) from a first configuration to a second configuration in response to a load and recover the first configuration in response to removal of the load. For example, in this embodiment, the resilient element 554 comprises an elastomeric material 556 (e.g., rubber). In other embodiments, the resilient element 554 comprises a spring, such as a coil spring (e.g., a metallic or polymeric coil spring), an elastomeric spring (e.g., a rubber spring), a leaf spring, a fluid spring (i.e., a spring including a liquid or gas contained in a container such as a cylinder or a bellows and variably compressed by a piston or other structure, such as an air spring or other gas spring or a piston-cylinder arrangement), or any other elastic object that changes in configuration under load and recovers its initial configuration when the load is removed.

The frame 523 of the track system 514 may be configured in any suitable way. In this embodiment, the frame 523 of the track system 514 comprises an elongate support 562 that has a single rail 544 (e.g., a single-rail suspension, as discussed above) disposed in a central region of the track-engaging assembly 524 where it overlaps a centerline 585 of the track 521. The frame 523, including the rail 544, may be constructed according to principles discussed herein, including as discussed above in respect of the frame 23 and the rail 44 of the track system 14, notably such that, when the snow bike 510 travels on the ground, a sliding surface 577 of the elongate support 562 is movable relative to the frame 511 of the snow bike 510 to change an orientation of the sliding surface 577 relative to the frame 511 of the snow bike 510. In this example, the rail 544, including its sliding surface 577, is aligned (i.e., overlaps) with the ski 528 of the ski system 517 in the widthwise direction of the snow bike 510.

In this embodiment, the subframe 529 comprises a pair of elongated lateral members 558₁, 558₂ that are elongated in a longitudinal direction of the track system 514 and disposed outside of lateral edges 566₁, 566₂ of the track 521. As shown in FIG. 43 which portrays a top cross-sectional view of an elongated lateral member 558ₓ, in this embodiment, the elongated lateral member 558ₓ comprises a first portion 560 and a second portion 563 that projects laterally outwardly from the first portion 560 to define a recess 564 to receive the sprockets 538, 540 and the chain 536. The first portion 560 of the elongated lateral member 558ₓ is thus closer to the track 521 than the second portion 563 of that elongated lateral member 558ₓ in the widthwise direction of the track system 514. This reduces an envelope of the track system 514, which may provide more space for the user (e.g., around footrests of the motorcycle 510).

In this embodiment, each of the elongated lateral members 558₁, 558₂ is plate-like with its first portion 560 being generally planar. The elongated lateral members 558₁, 558₂ may have any other suitable shape in other embodiments. Moreover, in some embodiments, the subframe 529 may comprise additional elongated lateral members 567₁, 567₂ configured to be connected with the elongated lateral members 558₁, 558₂ in order to cover the transmission 527.

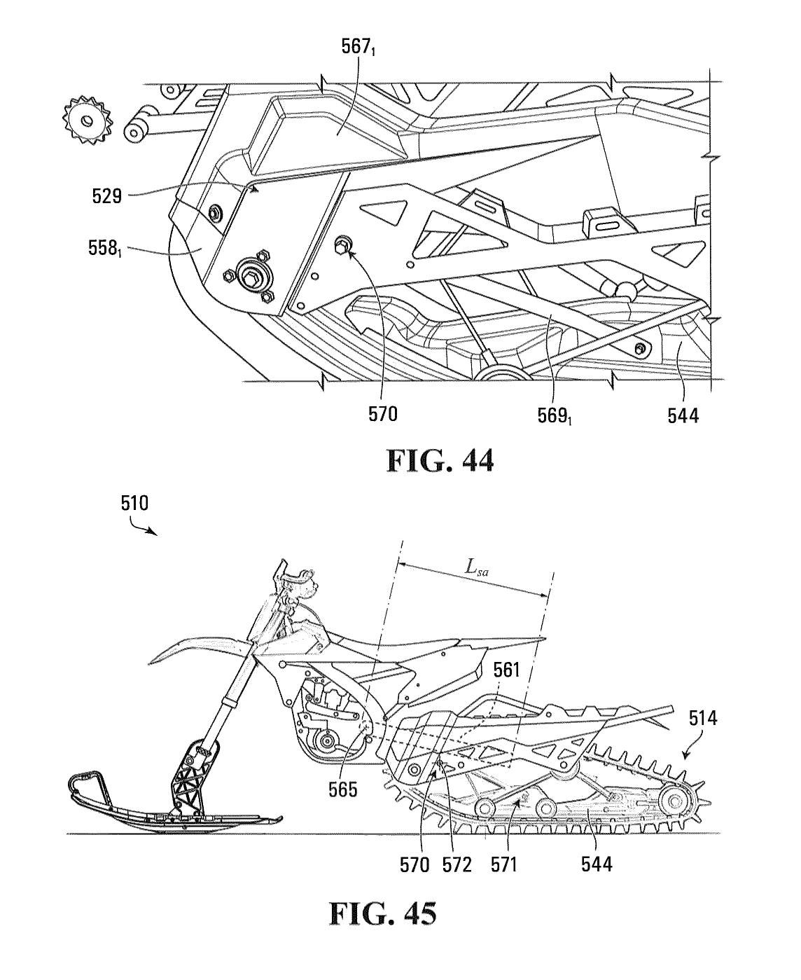

In this embodiment, as shown in FIG. 44, a frame member 569₁ of the frame 523 of the track system 514 (corresponding generally to the frame member 49₁ of the frame 23 of the track system 14) extends upwardly and forwardly from the rail 544 to the subframe 529 of the mounting arrangement 519 to interconnect the rail 544 and the subframe 529 such that the rail 544 is movable relative to the subframe 529. In this embodiment, the rail 544 is pivotable relative to the subframe 529. More particularly, in this embodiment, the frame member 569₁ is pivotally mounted to the subframe 529 at a pivot 570 and pivotally mounted to the rail 544 at a pivot 571.

In some embodiments, a pivot axis 572 of the pivot 570 between the frame member 569₁ of the frame 523 and the subframe 529 may be located so as to optimally balance loading (e.g., weight) between the track system 514 in the rear of the snow bike 510 and the ski system 517 in the front of the snow bike 10.

For example, in this embodiment where the track system 514 replaces the rear wheel 604 of the motorcycle 510 that would be carried by the swing arm 561, a distance between the pivot axis 565 of the motorcycle 510 and the pivot axis 258 of the pivot 253 between the frame member 569₁ and the subframe 529 may be related to (e.g., less than) a length Lₛₐ of the swing arm 561 of the motorcycle 510 that has been removed. For instance, with additional reference to FIG. 45, in some embodiments, a ratio of (i) the distance between the pivot axis 565 of the motorcycle 510 and the pivot axis 572 of the pivot 570 between the frame member 569₁ and the subframe 529 over (ii) the length Lₛₐ of the swing arm 561 of the motorcycle 510 that has been removed may be no more than 0.8, in some cases no more than 0.7, in some cases no more than 0.6, and in some cases even less (e.g., 0.5).

This positioning of the pivot axis 572 of the pivot 570 may allow a better distribution of the weight of the snow bike 510 between the ski system 517 and the track system 514 compared to conventional track system designs. For example, this may allow a decreased weight being applied at the ski system 517 compared to similar vehicles equipped with conventional track designs. In some cases, it may enhance performance of the snow bike 10 on flat and rough terrain and/or result in a better balance of stability and hill climbing ability of the snow bike 510.

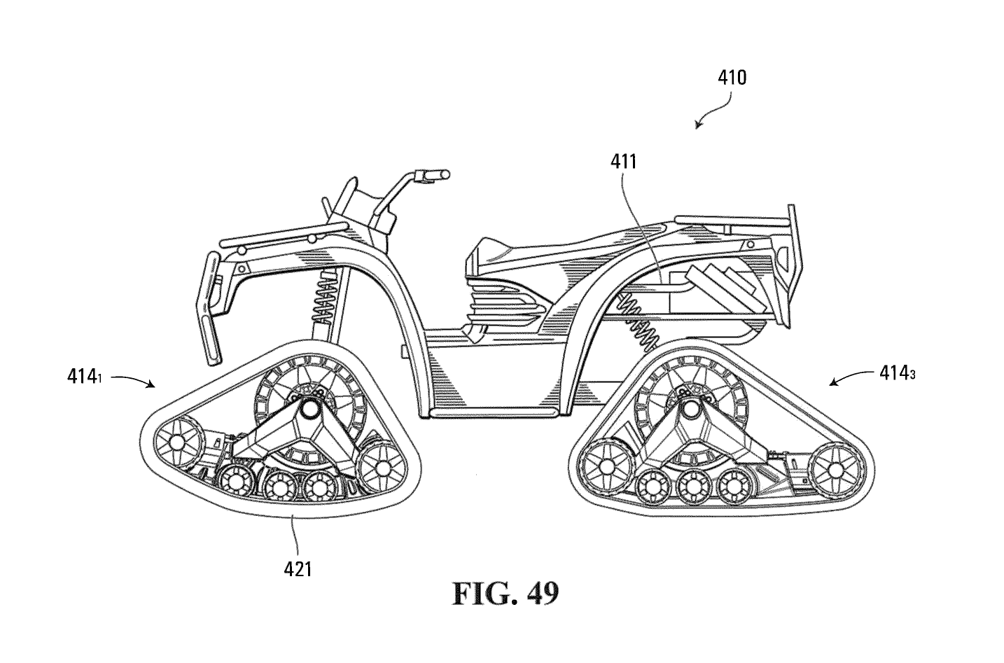

The track 521 may be relatively wide. This may provide enhanced floatation in deep snow and/or enhance traction in wet snow. Moreover, this may allow the track system 514 to be mounted to larger or heavier motorcycles. Also, in this example, the track 521 may be relatively wide because the track system 514 does not rely on the motorcycle's rear suspension unit and is therefore less constrained. For example, in some embodiments, with reference to FIGS. 47 and 49 a ratio of a width Wₜ of the track 521 over a width W_{w} of a tire 606 of the rear wheel 604 of the motorcycle that is replaced by the track system 514 may be greater than two, in some cases at least 2.1, in some cases at least 2.2, in some cases at least 2.3, in some cases at least 2.4, and in some cases even more (e.g., at least 2.5) This ratio may have any other value in other embodiments. As another example, in some embodiments, a ratio of the width Wₜ of the track 521 over a width Wₛ of a sliding surface 577 of an elongate support 562 of the track-engaging assembly 524 may be greater than 4.5, in some cases at least 5, in some cases at least 5.5, in some cases at least 6, in some cases at least 6.5 and in some cases even more. This ratio may have any other value in other embodiments. For instance, in some embodiments, the width Wₜ of the track 521 may be greater than 10 inches, in some cases at least 11 inches, in some cases at least 12 inches, and in some cases even more (e.g., at least 12.5 inches).

Although in this embodiment the snow bike 510 is a motorcycle in which the ski system 517 and the track system 514 are part of the conversion system 513 that is mounted in place of the front wheel 602 and the rear wheel 604 of the motorcycle, in other embodiments, the snow bike 510 may be designed and originally built with the ski system 517 and the track system 514 by a manufacturer of the snow bike 510, i.e., the snow bike 10 may never have been a motorcycle.

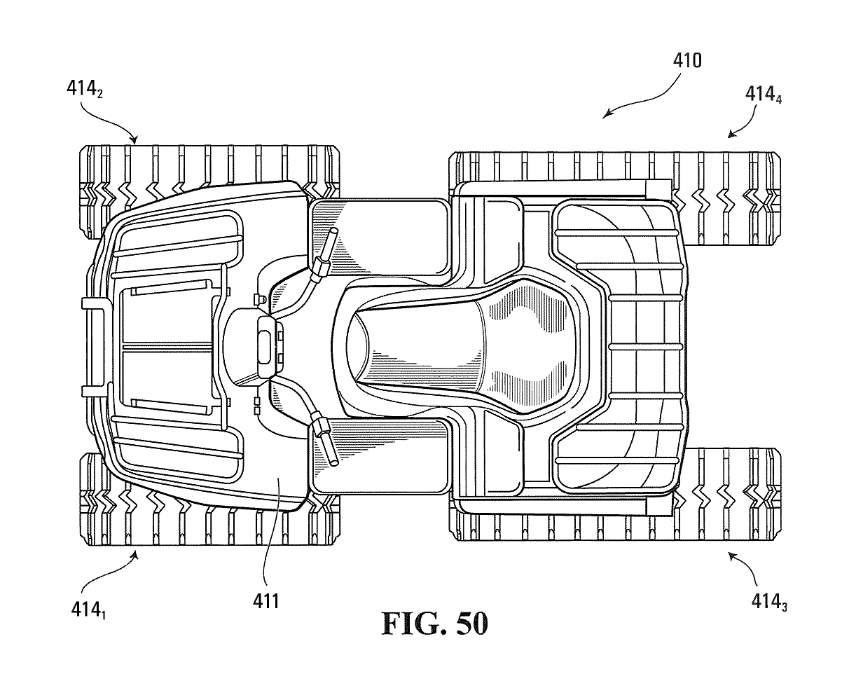

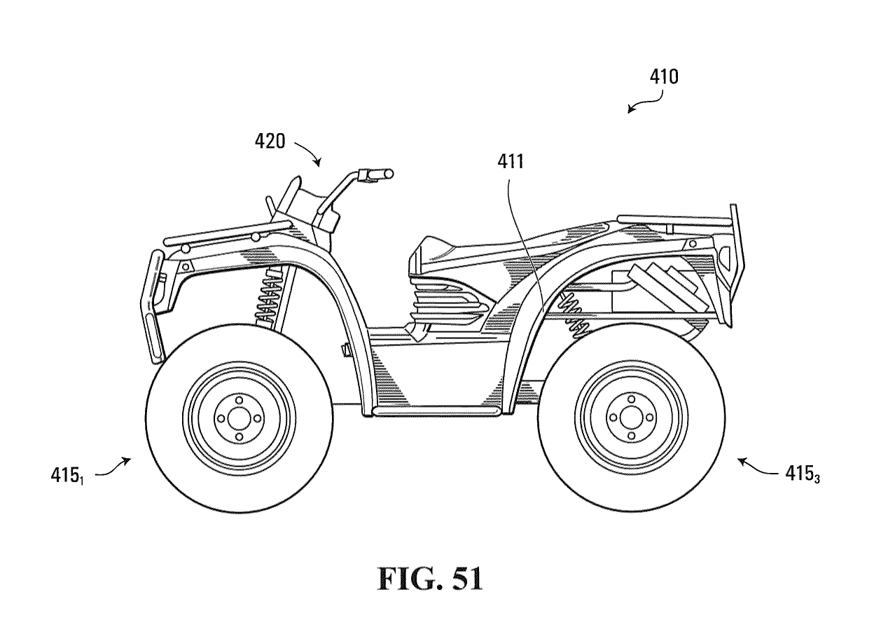

As another example, in some embodiments, as shown in FIGS. 50 and 51, a track system 414 including a track 421 constructed according to principles discussed herein may be used as part of an all-terrain vehicle (ATV) 410. More specifically, in this example, the track system 414 is one of a plurality of track systems 414₁-414₄ of the ATV 410 that engages the ground to provide traction to the ATV 410. In this example, front ones of the track systems 414₁-414₄ provide front traction to the ATV 410 while rear ones of the track systems 414₁-414₄ provide rear traction to the ATV 410.

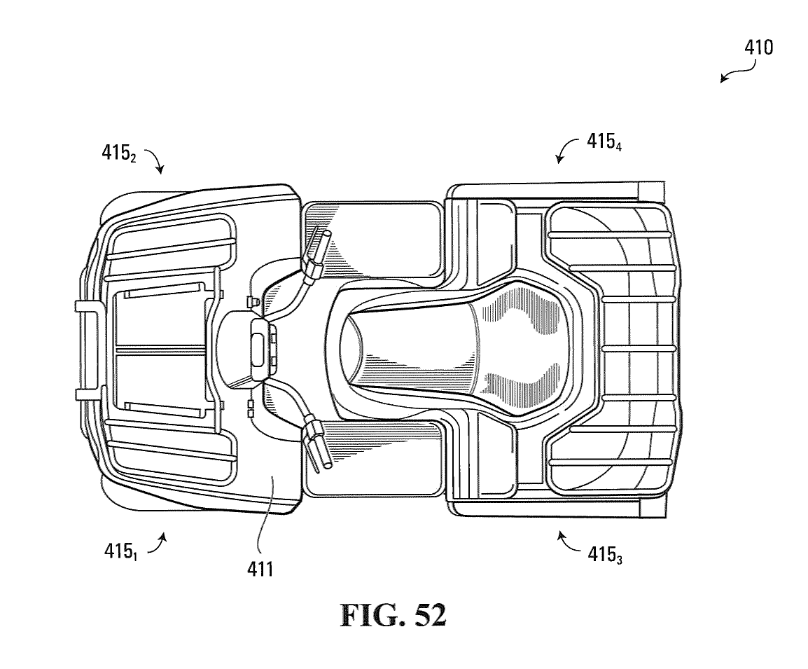

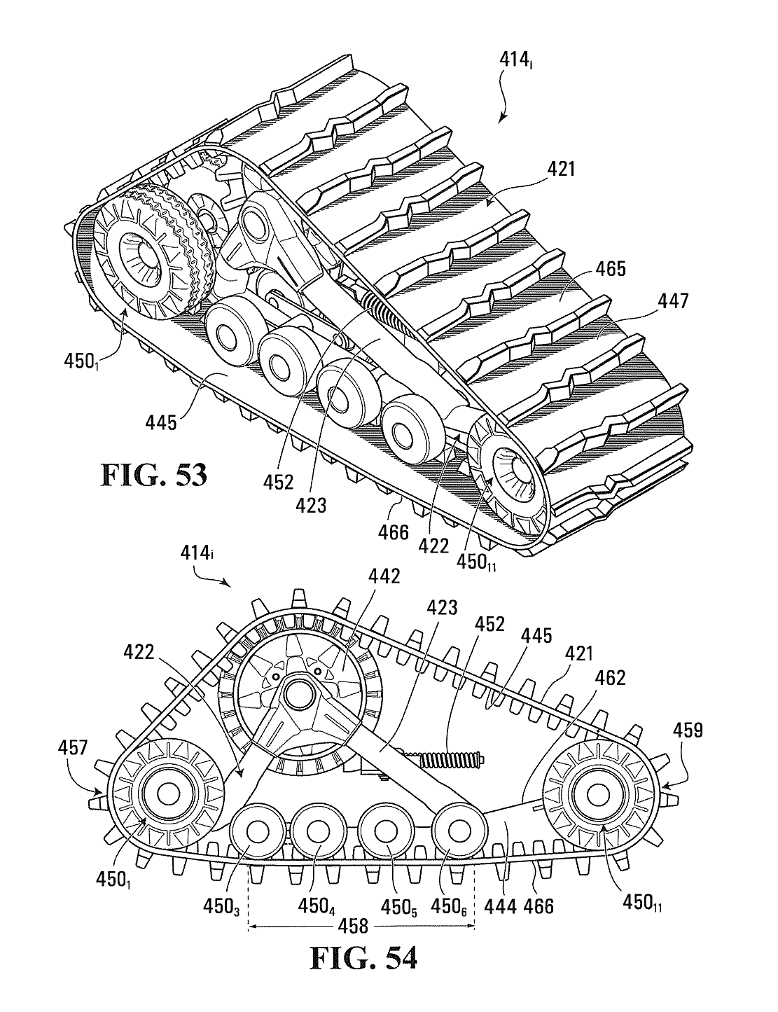

Moreover, in this example, each track system 414; is mounted in place of a ground-engaging wheel 415 that may otherwise be mounted at a position of the track system 414 to propel the ATV 410 on the ground. For example, as shown in FIGS. 52 and 53, the ATV 410 may be propelled on the ground by four ground-engaging wheels 415₁-415₄ having tires instead of by the track systems 414₁-414₄. Basically, in this embodiment, the track systems 414₁-414₄ may be used to convert the ATV 410 from a wheeled vehicle into a tracked vehicle, thereby enhancing its traction and floatation on the ground.

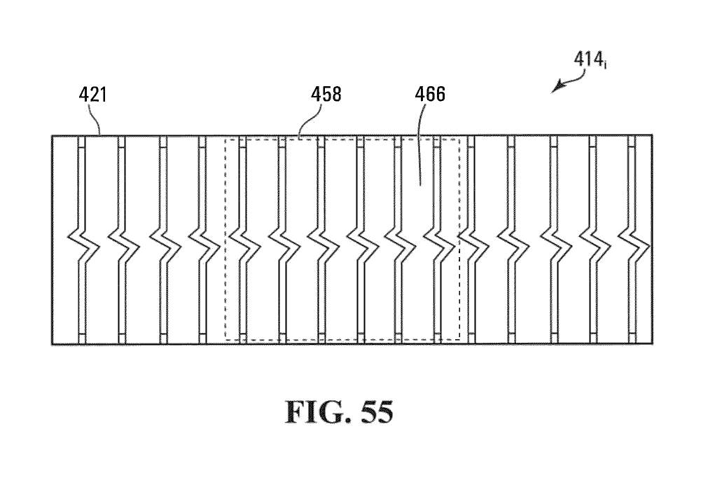

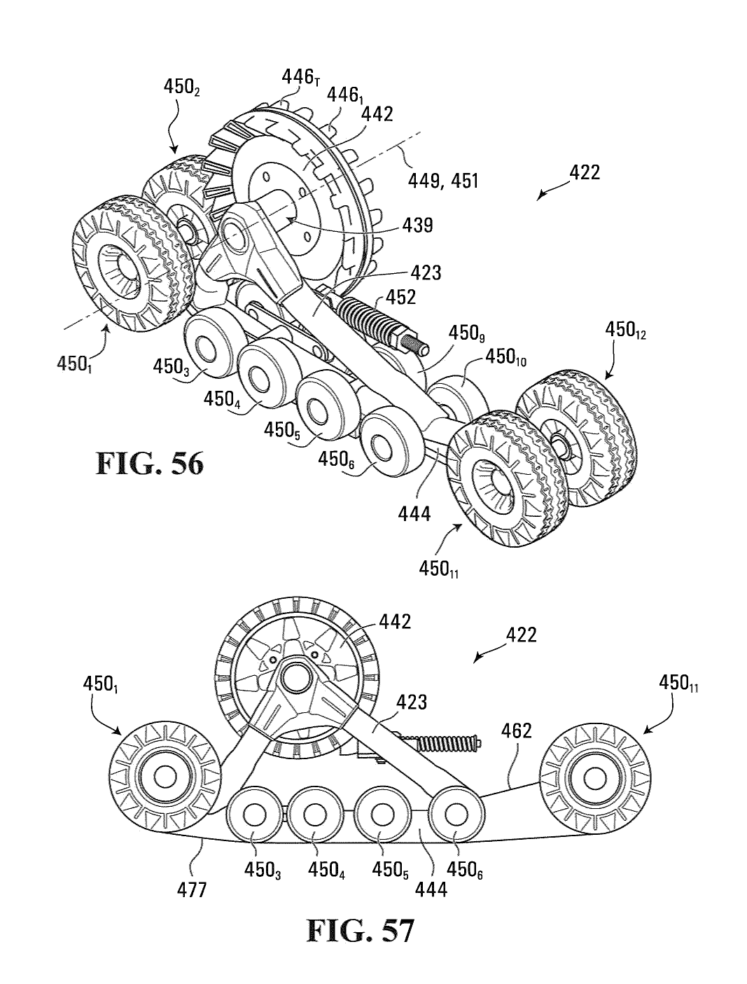

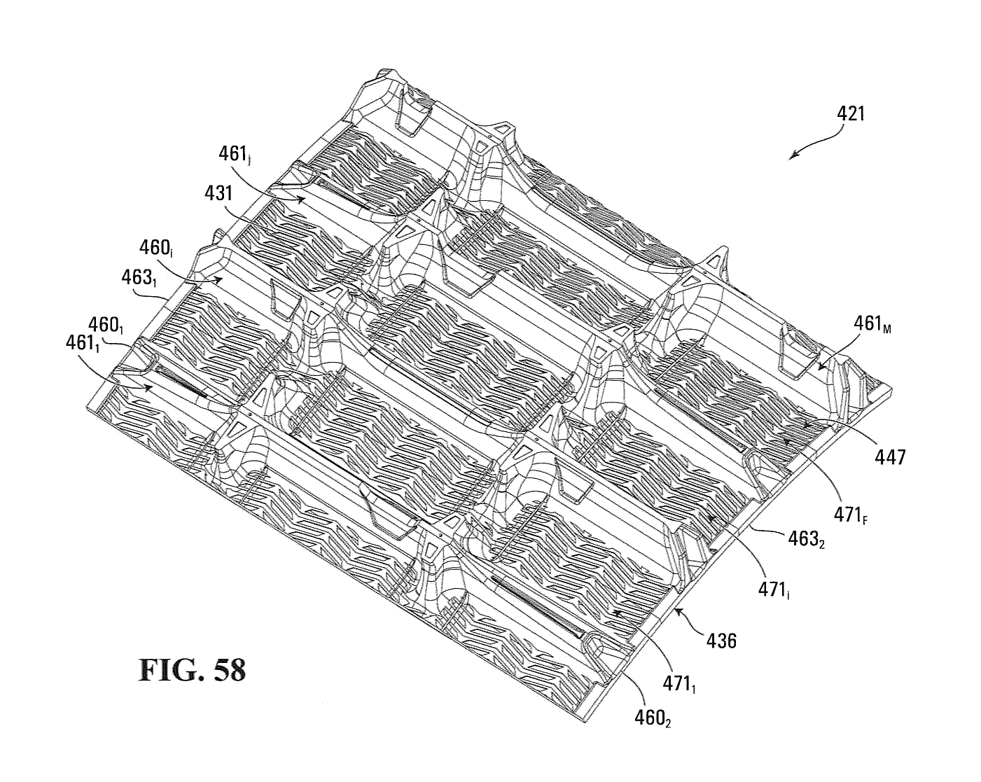

With additional reference to FIGS. 54 to 58, in this embodiment, each track system 414; comprises a track-engaging assembly 422 and a track 421 disposed around the track-engaging assembly 422. In this example, the track-engaging assembly 422 comprises a frame 423 and a plurality of track-contacting wheels which includes a drive wheel 442 and a plurality of idler wheels 450₁-450₁₂. The track system 414; has a front longitudinal end 457 and a rear longitudinal end 459 that define a length of the track system 414₁. The frame 423 supports the plurality of idler wheels 450₁-450₁₂.

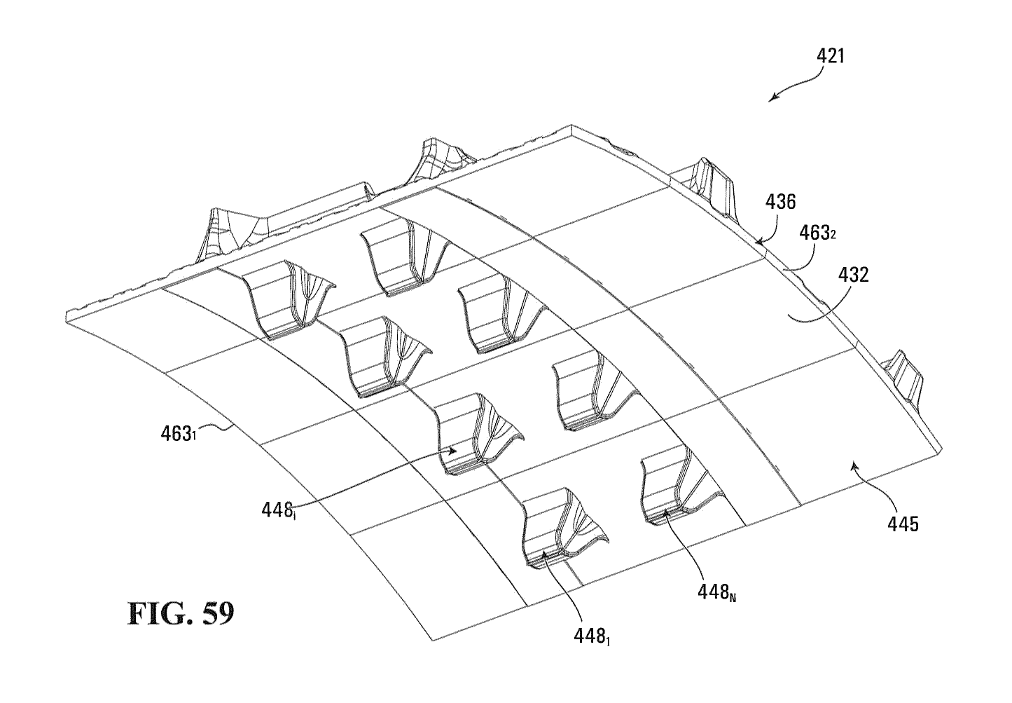

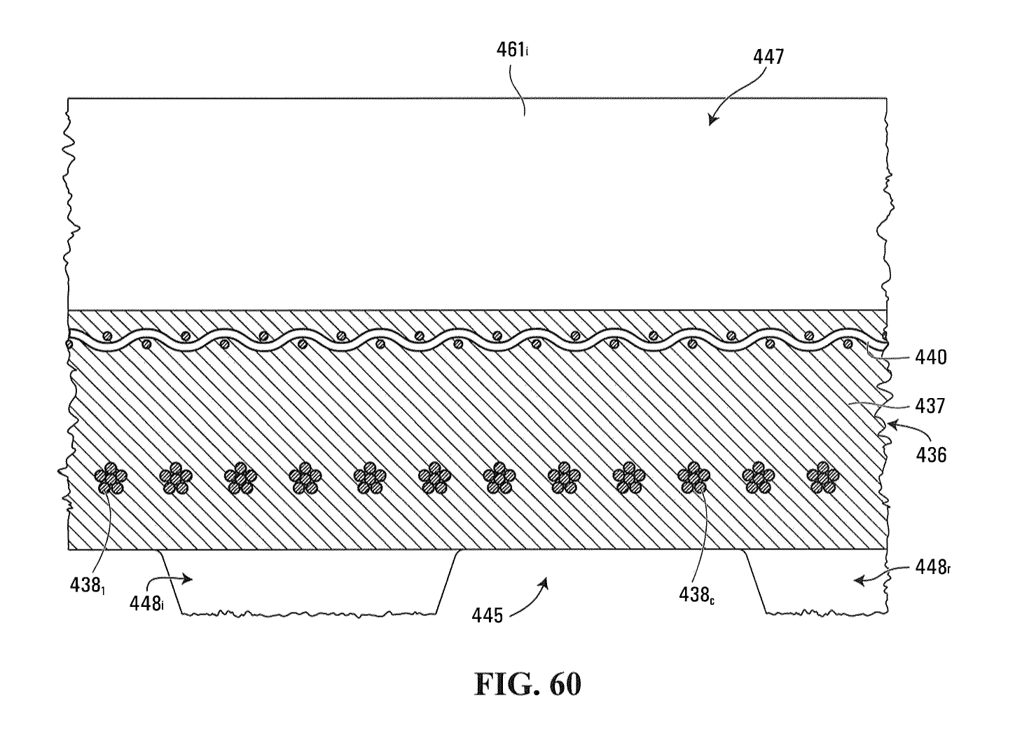

The track 421 is mounted around the track-engaging assembly 422 and engages the ground to provide traction to the ATV 410. Referring additionally to FIGS. 59 and 60, the track 421 comprises an inner side 445 facing the wheels 442, 450₁-450₁₂ and defining an inner area of the track 421 in which these wheels are located. The track 421 also comprises a ground-engaging outer side 447 opposite the inner side 445 for engaging the ground on which the ATV 410 travels. Lateral edges 463₁, 463₂ of the track 421 define the track's width. The track 421 has a top run 465 which extends between the longitudinal ends 457, 459 of the track system 414ₓ and over the drive wheel 442, and a bottom run 466 which extends between the longitudinal ends 457, 459 of the track system 414; and under the idler wheels 450₁-450₁₂. The bottom run 466 of the track 421 defines an area of contact 458 of the track 421 with the ground which generates traction and bears a majority of a load on the track system 414ᵢ, and which will be referred to as a “contact patch” of the track 421 with the ground.

The track 421 comprises an elastomeric belt-shaped body 436 underlying its inner side 445 and its ground-engaging outer side 447. In view of its underlying nature, the body 436 can be referred to as a “carcass”. The carcass 436 comprises elastomeric material 437 which allows the track 421 to flex around the wheels 442, 450₁-450₁₂.

As shown in FIG. 60, in this embodiment, the carcass 436 comprises a plurality of reinforcements embedded in its elastomeric material 437. One example of a reinforcement is a layer of reinforcing cables 438₁-438_{C} that are adjacent to one another and that extend in the longitudinal direction of the track 421 to enhance strength in tension of the track 421 along its longitudinal direction. In some cases, a reinforcing cable may be a cord or wire rope including a plurality of strands or wires. In other cases, a reinforcing cable may be another type of cable and may be made of any material suitably flexible longitudinally (e.g., fibers or wires of metal, plastic or composite material). Another example of a reinforcement is a layer of reinforcing fabric 440. Reinforcing fabric comprises pliable material made usually by weaving, felting, or knitting natural or synthetic fibers. For instance, a layer of reinforcing fabric may comprise a ply of reinforcing woven fibers (e.g., nylon fibers or other synthetic fibers). Various other types of reinforcements may be provided in the carcass 436 in other embodiments.

The carcass 436 may be molded into shape in the track's molding process during which its elastomeric material 437 is cured. For example, in this embodiment, layers of elastomeric material providing the elastomeric material 437 of the carcass 436, the reinforcing cables 438₁-438_{C} and the layer of reinforcing fabric 40 may be placed into the mold and consolidated during molding.

In this embodiment, the inner side 445 of the track 421 comprises an inner surface 432 of the carcass 436 and a plurality of wheel-contacting projections 448₁-448_{N} that project from the inner surface 432 to contact at least some of the wheels 442, 450₁-450₁₀ and that are used to do at least one of driving (i.e., imparting motion to) the track 421 and guiding the track 421. In that sense, the wheel-contacting projections 448₁-448_{N} can be referred to as “drive/guide projections”, meaning that each drive/guide projection is used to do at least one of driving the track 421 and guiding the track 421. Also, such drive/guide projections are sometimes referred to as “drive/guide lugs” and will thus be referred to as such herein. More particularly, in this embodiment, the drive/guide lugs 448₁-448_{N} interact with the drive wheel 442 in order to cause the track 421 to be driven, and also interact with the idler wheels 450₁-450₁₂ in order to guide the track 421 as it is driven by the drive wheel 442.

The ground-engaging outer side 447 of the track 421 comprises a ground-engaging outer surface 431 of the carcass 436 and a plurality of traction projections 461₁-461_{M} that project from the outer surface 431 and engage and may penetrate into the ground to enhance traction. The traction projections 461₁-461_{M}, which can sometimes be referred to as “traction lugs” or “traction profiles”, are spaced apart in the longitudinal direction of the track system 414ᵢ. The ground-engaging outer side 447 comprises a plurality of traction-projection-free areas 471₁-471_{F} (i.e., areas free of traction projections) between successive ones of the traction projections 461₁-461_{M}. In this example, each of the traction projections 461₁-461_{M} is an elastomeric traction projection in that it comprises elastomeric material 469. The traction projections 461₁-461_{M} can be provided and connected to the carcass 436 in the mold during the track's molding process.

The frame 423 of the track system 414 may be configured in any suitable way. In this embodiment, the frame 423 of the track system 414 comprises an elongate support 462 that has a single rail 444 (e.g., a single-rail suspension, as discussed above) disposed in a central region of the track-engaging assembly 424 where it overlaps a centerline 485 of the track 421. The frame 423, including the rail 444, may be constructed according to principles discussed herein, including as discussed above in respect of the frame 23 and the rail 44 of the track system 14, notably such that, when the ATV 410 travels on the ground, a sliding surface 477 of the elongate support 462 is movable relative to a frame 411 of the ATV 410 to change an orientation of the sliding surface 477 relative to the frame 411 of the ATV 410.

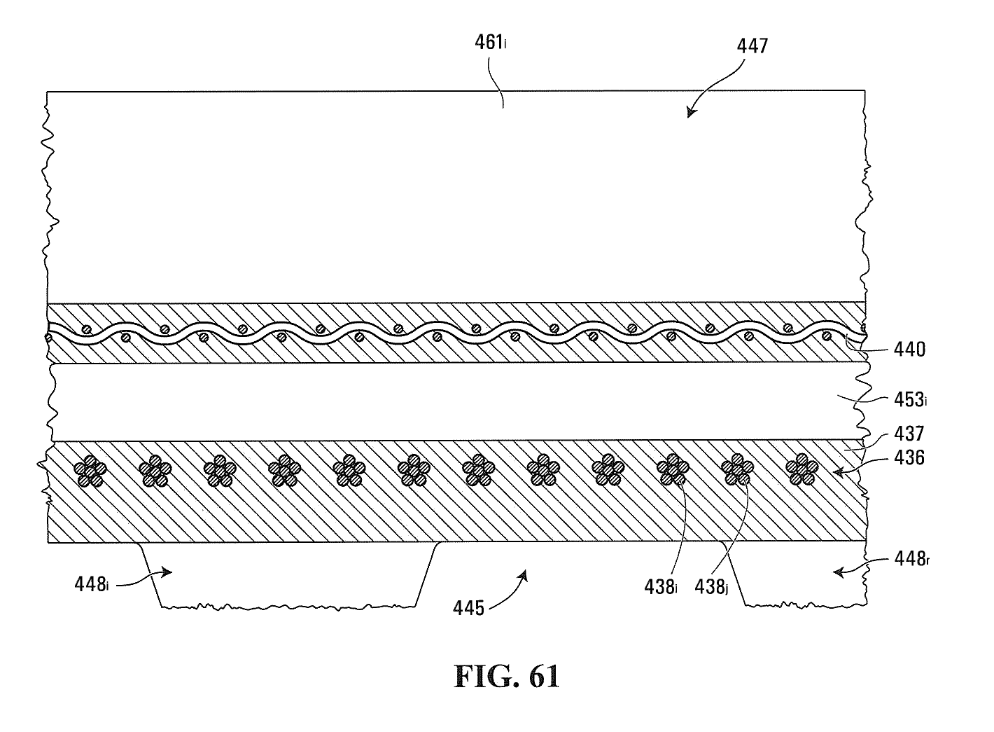

In this embodiment, as shown in FIG. 60, the track 421 is free of transversal stiffening rods embedded in its elastomeric material. That is, the track 421 does not comprise transversal stiffening rods embedded in its elastomeric material and extending transversally to its longitudinal direction. FIG. 61 shows a variant in which the track 421 may comprise transversal stiffening rods 453₁-453_{M} embedded in its elastomeric material and extending transversally to its longitudinal direction in other embodiments. This absence of transversal stiffening rods in some embodiments, such as shown in FIG. 60, makes the track 421 more flexible in its widthwise direction than if the track 421 had the transversal stiffening rods 453₁-453_{M} but was otherwise identical.

This implementation may be particularly useful where the track 421 is free of stiffening rods 453₁-453_{M}. More specifically, proper engagement of the track 421 with the ground (i.e., the contact patch 458) may be further improved in light of principles described herein when the track 421 is free of stiffening rods 453₁-453_{M} relative to when the track comprises stiffening rods 453₁-453_{M}.

The snowmobile 10, the snow bike 510, and the ATV 410 considered above are examples of recreational vehicles. While they can be used for recreational purposes, such recreational vehicles may also be used for utility purposes in some cases.

While these examples pertain to recreational vehicles, a track system constructed according to principles discussed herein may be used as part of off-road vehicles other than recreational ones in other embodiments. For example, in some embodiments, a track system constructed according to principles discussed herein may be used as part of an agricultural vehicle (e.g., a tractor, a harvester, etc.), as part of a construction vehicle, forestry vehicle or other industrial vehicle, or as part of a military vehicle.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

In case of any discrepancy, inconsistency, or other difference between terms used herein and terms used in any document incorporated by reference herein, meanings of the terms used herein are to prevail and be used.

Although various embodiments and examples have been presented, this was for the purpose of describing, but not limiting, the invention. Various modifications and enhancements will become apparent to those of ordinary skill in the art and are within the scope of the invention, which is defined by the appended claims.

1. A track system for traction of a vehicle, the track system comprising:
a track comprising a ground-engaging outer side for engaging the ground and an inner side opposite to the ground-engaging outer side; and
a track-engaging assembly for driving and guiding the track around the track-engaging assembly, the track-engaging assembly comprising:
a drive wheel for driving the track; and
an elongate support comprising a rail extending in a longitudinal direction of the track system along a bottom run of the track, the elongate support comprising a sliding surface for sliding on the inner side of the track along the bottom run of the track, the rail comprising an upper portion and a lower portion between the upper portion and the sliding surface, wherein, when the vehicle travels on the ground, the upper portion of the rail is movable relative to the sliding surface to change an orientation of the upper portion of the rail relative to the sliding surface.

2. The track system of claim 1, wherein the upper portion of the rail is rotatable relative to the sliding surface about a roll axis substantially parallel to the longitudinal direction of the track system to change the orientation of the upper portion of the rail relative to the sliding surface.

3. The track system of claim 1, wherein the upper portion of the rail is movable relative to the sliding surface in response to leaning of the vehicle relative to the ground.

4. The track system of claim 1, wherein the upper portion of the rail is movable relative to the sliding surface in response to an unevenness of the ground in a widthwise direction of the track system.

5. The track system of claim 1, wherein the lower portion of the rail is resiliently deformable to allow movement of the upper portion of the rail relative to the sliding surface.

6. The track system of claim 5, wherein a stiffness of the lower portion of the rail is less than a stiffness of the upper portion of the rail.

7. The track system of claim 5, wherein a stiffness of the lower portion of the rail is no more than 1.0E4 GPa/mm⁴.

8. The track system of claim 5, wherein a stiffness of the lower portion of the rail is no more than 5.0E3 GPa/mm⁴.

9. The track system of claim 5, wherein a stiffness of the lower portion of the rail is no more than 1.0E3 GPa/mm⁴.

10. The track system of claim 5, wherein a modulus of elasticity of a material of the lower portion of the rail is no more than 10 GPa.

11. The track system of claim 5, wherein a modulus of elasticity of a material of the lower portion of the rail is no more than 5 GPa.

12. The track system of claim 5, wherein a modulus of elasticity of a material of the lower portion of the rail is no more than 1 GPa.

13. The track system of claim 5, wherein the lower portion of the rail comprises a polymeric material.

14. The track system of claim 5, wherein the rail comprises a hollow interior.

15. The track system of claim 14, wherein the rail comprises a wall defining the hollow interior and a thickness of the wall is no more than 8 mm.

16. The track system of claim 14, wherein the rail comprises a wall defining the hollow interior and a thickness of the wall is no more than 5 mm.

17. The track system of claim 14, wherein the rail comprises a wall defining the hollow interior and a thickness of the wall is no more than 3 mm.

18. The track system of claim 5, wherein the rail is a blow-molded rail.

19. The track system of claim 1, wherein the elongate support comprises a movable mechanical joint between the upper portion of the rail and the sliding surface to allow movement of the upper portion of the rail relative to the sliding surface.

20. The track system of claim 19, wherein the movable mechanical joint comprises a pivot to allow pivoting of the upper portion of the rail relative to the sliding surface.

21. The track system of claim 19, wherein the movable mechanical joint comprises a resilient device biasing the orientation of the upper portion of the rail relative to the sliding surface towards a predetermined orientation.

22. The track system of claim 20, wherein the movable mechanical joint comprises a resilient device biasing the orientation of the upper portion of the rail relative to the sliding surface towards a predetermined orientation.

23. The track system of claim 1, wherein the elongate support comprises a slider mounted to the lower portion of the rail and the slider comprises the sliding surface.

24. The track system of claim 23, wherein the slider is mechanically interlocked with the rail.

25. The track system of claim 23, wherein the slider is fastened to the rail.

26. The track system of claim 23, wherein the lower portion of the rail is resiliently deformable to allow movement of the upper portion of the rail relative to the sliding surface.

27. The track system of claim 23, wherein the slider is resiliently deformable to allow movement of the upper portion of the rail relative to the sliding surface.

28. The track system of claim 27, wherein a stiffness of the slider is less than a stiffness of the upper portion of the rail.

29. The track system of claim 27, wherein a stiffness of the slider is no more than 1.0E4 GPa/mm⁴.

30. The track system of claim 27, wherein a stiffness of slider is no more than 5.0E3 GPa/mm⁴.

31. The track system of claim 27, wherein a stiffness of the slider is no more than 1.0E3 GPa/mm⁴.

32. The track system of claim 27, wherein a modulus of elasticity of a material of the slider is no more than 10 GPa.

33. The track system of claim 27, wherein a modulus of elasticity of a material of the slider is no more than 5 GPa.

34. The track system of claim 27, wherein a modulus of elasticity of a material of the slider is no more than 1 GPa.

35. The track system of claim 27, wherein the slider comprises a polymeric material.

36. The track system of claim 23, wherein the elongate support comprises a movable mechanical joint between the upper portion of the rail and the slider to allow movement of the upper portion of the rail relative to the sliding surface.

37. The track system of claim 36, wherein the movable mechanical joint comprises a pivot to allow pivoting of the upper portion of the rail relative to the sliding surface.

38. The track system of claim 36, wherein the movable mechanical joint comprises a resilient device biasing the orientation of the upper portion of the rail relative to the sliding surface towards a predetermined orientation.

39. The track system of claim 37, wherein the movable mechanical joint comprises a resilient device biasing the orientation of the upper portion of the rail relative to the sliding surface towards a predetermined orientation.

40. The track system of claim 1, wherein the sliding surface is part of the lower portion of the rail.

41. The track system of claim 1, wherein the vehicle is a snowmobile.

42. The track system of claim 1, wherein the vehicle is a snow bike.

43. The track system of claim 1, wherein the vehicle is an all-terrain vehicle (ATV).

44. A track system for traction of a vehicle, the vehicle comprising a frame and a powertrain mounted to the frame, the track system comprising:
a track comprising a ground-engaging outer side for engaging the ground and an inner side opposite to the ground-engaging outer side; and
a track-engaging assembly for driving and guiding the track around the track-engaging assembly, the track-engaging assembly comprising:
a drive wheel for driving the track; and
a rail extending in a longitudinal direction of the track system along a bottom run of the track, the rail overlapping a centerline of the track in a widthwise direction of the track system;
wherein, when the vehicle travels on the ground, a surface of the track-engaging assembly in contact with the bottom run of the track is movable relative to the frame of the vehicle to change an orientation of the surface of the track-engaging assembly in contact with the bottom run of the track relative to the frame of the vehicle.

45. The track system of claim 44, wherein the surface of the track-engaging assembly in contact with the bottom run of the track is rotatable relative to the frame of the vehicle about a roll axis substantially parallel to the longitudinal direction of the track system to change the orientation of the surface of the track-engaging assembly in contact with the bottom run of the track relative to the frame of the vehicle.

46. The track system of claim 44, wherein: the track-engaging assembly comprises an upper part and a lower part that comprises the surface of the track-engaging assembly in contact with the bottom run of the track; and, when the vehicle travels on the ground, the upper part of the track-engaging assembly is movable relative to the lower part of the track-engaging assembly to change an orientation of the upper part of the track-engaging assembly relative to the lower part of the track engaging assembly in order to change the orientation of the surface of the track-engaging assembly in contact with the bottom run of the track relative to the frame of the vehicle.

47. The track system of claim 46, wherein the upper part of the track-engaging assembly is rotatable relative to the lower part of the track-engaging assembly about a roll axis substantially parallel to the longitudinal direction of the track system to change the orientation of the upper part of the track-engaging assembly relative to the lower part of the track-engaging assembly.

48. The track system of claim 46, wherein the track-engaging assembly is resiliently deformable to allow movement of the upper part of the track-engaging assembly relative to the lower part of the track-engaging assembly.

49. The track system of claim 46, wherein the track-engaging assembly comprises a movable mechanical joint between the upper part of the track-engaging assembly and the lower part of the track-engaging assembly to allow movement of the upper part of the track-engaging assembly relative to the lower part of the track-engaging assembly.

50. The track system of claim 49, wherein the movable mechanical joint comprises a pivot to allow pivoting of the upper part of the track-engaging assembly relative to the lower part of the track-engaging assembly.

51. A track system for traction of a motorcycle, the track system being mountable in place of a rear wheel of the motorcycle, the track system comprising:
a track comprising a ground-engaging outer side for engaging the ground and an inner side opposite to the ground-engaging outer side, a ratio of a width of the track over a width of a tire of the rear wheel of the motorcycle being greater than 2; and
a track-engaging assembly for driving and guiding the track around the track-engaging assembly, the track-engaging assembly comprising:
a drive wheel for driving the track; and
a rail extending in a longitudinal direction of the track system along a bottom run of the track, the rail overlapping a centerline of the track in a widthwise direction of the track system.

52. A track system for traction of a motorcycle, the track system being mountable in place of a rear wheel of the motorcycle, the track system comprising:
a track comprising a ground-engaging outer side for engaging the ground and an inner side opposite to the ground-engaging outer side; and
a track-engaging assembly for driving and guiding the track around the track-engaging assembly, the track-engaging assembly comprising:
a drive wheel for driving the track; and
an elongate support comprising a rail extending in a longitudinal direction of the track system along a bottom run of the track, the elongate support comprising a sliding surface for sliding on the inner side of the track along the bottom run of the track, the rail overlapping a centerline of the track in a widthwise direction of the track system;
wherein a ratio of a width of the track over a width of the sliding surface is at least 5.

53. A track system for traction of a motorcycle, the track system being mountable in place of a rear wheel of the motorcycle, the track system comprising:
a track comprising a ground-engaging outer side for engaging the ground and an inner side opposite to the ground-engaging outer side, a width of the track being greater than 10 inches; and
a track-engaging assembly for driving and guiding the track around the track-engaging assembly, the track-engaging assembly comprising:
a drive wheel for driving the track; and
a rail extending in a longitudinal direction of the track system along a bottom run of the track, the rail overlapping a centerline of the track in a widthwise direction of the track system.

54. A track system for traction of a motorcycle, the track system being mountable in place of a rear wheel of the motorcycle, the track system comprising:
a track comprising a ground-engaging outer side for engaging the ground and an inner side opposite to the ground-engaging outer side; and
a track-engaging assembly for driving and guiding the track around the track-engaging assembly, the track-engaging assembly comprising:
a drive wheel for driving the track; and
an elongate support comprising a rail extending in a longitudinal direction of the track system along a bottom run of the track, the elongate support comprising a sliding surface for sliding on the inner side of the track along the bottom run of the track, the rail comprising an upper portion and a lower portion between the upper portion and the sliding surface, wherein, when the motorcycle travels on the ground, the upper portion of the rail is movable relative to the sliding surface to change an orientation of the upper portion of the rail relative to the sliding surface.
